(19) United States
(12) Patent Application Publication
(10) Pub. No.: US 2010/0194144 A1
(43) Pub. Date: Aug. 5, 2010

(54) DETURBULATOR FUEL ECONOMY ENHANCEMENT FOR TRUCKS

(76) Inventor: Sumon K. Sinha, Oxford, MS (US)

Correspondence Address: Sawyer Law Group, P.C., P.O. Box 51418, Palo Alto, CA, 94303, US

(21) Appl. No.: 12/671,502

(22) PCT Filed: Jul. 31, 2008
(86) PCT No.: PCT/US08/71822

§ 371 Date: Jan. 29, 2010

Related U.S. Application Data
(60) Provisional application No. 60/953,462, filed on Aug. 1, 2007.

(51) Int. Cl. B62D 35/00

(52) U.S. Cl. 296/180.2

(57) ABSTRACT

A method for reducing drag, for a truck using a deturbulating device is disclosed, with the preferred form of the deturbulator being a flexible composite sheet.

### FIELD OF THE INVENTION

The present invention relates to a method for using turbulence modifying flow-control devices to reduce drag on streamlined and bluff bodies, increase lift generated by lifting bodies and also increase convective heat transfer between a body and the flow without increasing flow losses.

### BACKGROUND OF THE INVENTION

Reduction of undesirable flow induced drag is important for enhancing the efficiencies of aircraft, automobiles and boats. Additionally, lifting surfaces such as wings also need to maximize lift generation while reducing drag so as to maximize the lift to drag ratio and minimize the size of the wing. Designers usually streamline objects as far as practical to reduce flow induced drag. For subsonic gas flows the primary drag generation mechanisms are viscous skin friction and separation of boundary layers leading to regions in the aft portion of the flow which have lower pressures than desired. Losses through turbulent eddies exacerbate pressure losses in regions of separated flow. Form or pressure drag arises out of the difference in pressures between the front and rear of the object. In addition, objects such as wings which are shaped to generate lift by inducing a pressure difference between the upper and lower surfaces also generate additional drag due to lift generation.

Heat exchangers are used for transferring heat in a variety of systems such as those for manufacturing, heating ventilating and air-conditioning, power generation, and electronic packaging. One goal in the design of a heat exchanger is to maximize the convective heat transfer between a working fluid and a solid wall. One way to do this is by increasing the velocity of the fluid, which enhances the wall convective heat transfer coefficient. However, as per the estimates of Kays and London (1984), while the heat transfer coefficient is directly proportional to the velocity, the power required to drive the flow is proportional to the square of the velocity. This imposes an upper limit on the maximum allowable velocities in the heat exchanger.

Most compact heat exchangers employ closely spaced fins or similar structures to augment the heat transfer area for a given device volume. Additional augmentation requires modifying the wall boundary layer flow, usually with the help of turbulence promoters, such as baffles or wall roughness elements. This is generally necessary for heat exchange from air streams due to significantly lower heat capacities and thermal conductivities of air compared to water or other commonly used liquid heat transfer media.

The principal problem of this solution is that using such turbulence promoters causes a significant drop in flow pressure, thereby increasing the power consumption of the fans. A second drawback is that turbulence promoters often snag solid particles or debris, thereby increasing flow blockage and heat transfer surface fouling in many instances.

Generally, there is not a good solution to these problems. Accordingly, what is needed is a system and method for increasing heat transfer while minimizing, or eliminating the additional flow pressure drop. The present invention also addresses such a need.

### SUMMARY OF THE INVENTION

A method for reducing drag, increasing lift and heat transfer using a de-turbulating device is disclosed, with the preferred form of the deturbulator being a flexible composite sheet.

The flexible composite sheet comprising a membrane, a substrate coupled to the membrane, and a plurality of ridges coupled between the membrane and the substrate, wherein a vibratory motion is induced from the flow to at least one segment of a membrane spanning a distances, wherein the vibratory motion is reflected from at least one segment of the membrane to the flow, and; wherein a reduction in fluctuations is caused in the flow pressure gradient and freestream velocity U at all frequencies except around f, where f≈U/s.

In one embodiment, the flexible composite sheet can be wrapped around a blunt leading edge of a plate facing an incoming flow of fluid. In another embodiment, the flexible composite sheet can also be wrapped around one or more regions of an aerodynamic surface where a flow pressure gradient changes from favorable to adverse. In another embodiment, the flexible composite sheet is replaced with a plurality of plates coupled to a substrate, wherein the plurality of plates has edges that interact with a fluid flow similar to a compliant surface.

A method of adding a system of small viscous sublayer scale (around 30-80 micron height) backward and/or forward facing steps on the surface of an airfoil or other 2-D or 3-D streamlined aerodynamic body is disclosed, where the backward facing step is in a favorable pressure gradient and forward facing step is in an adverse pressure gradient, so as to speed up the freestream flow over the front portion of the airfoil or body and reduce skin friction drag by creating a marginally separated thin (0.1 to 10 microns) slip layer next to the wall behind the backward facing step and extending a significant distance behind said step. This method reduces the drag and increases lift if the body is a wing. Also the same method can be applied to a bluff body, such as an automobile to reduce flow separation induced drag by stabilizing the wake flow and making it appear to the flow as a solid streamiling extension of the original body. The gas mileage of a vehicle improves when treated in this manner.

### BRIEF DESCRIPTION OF THE DRAWINGS

FIG. 1 is a diagram of a flexible composite surface (FCS) in accordance with the present invention;

FIG. 2 is a diagram of a portion of the FCS of FIG. 1 interacting with a flow of fluid in accordance with the present invention;

FIG. 3 shows a photograph of a Global-GT3 test aircraft;

FIG. 4 is a diagram showing the cross-section of the wing of FIG. 3;

FIG. 5 shows a photograph of an FCS mounted on the bottom of the wing of FIG. 3;

FIG. 6 is a chart showing measured pressure-side boundary-layer velocity profiles at 80% of chord from the leading edge, with and without the FCS;

FIG. 7 is a chart showing measured suction-side boundary-layer velocity profiles, with and without the FCS at 80% of chord from the leading edge;

FIG. 8 is a chart showing plots of the pressure-side velocity data of FIG. 6 normalized with respect to the measured velocities furthest away from the wall;

FIG. 9 is a diagram of an FCS interacting with a flow of fluid in accordance with another embodiment of the present invention;

FIG. 10 is a blow-up diagram of a portion of the FCS of FIG. 9 interacting with a flow of fluid in accordance with another embodiment of the present invention;

FIG. 11 is a diagram an FCS interacting with a flow of fluid in accordance with another embodiment of the present invention;

FIG. 12 is a diagram of a heat transfer enhancement test apparatus in accordance with another embodiment of the present invention;

FIG. 13 is a top-view diagram of a multi-fin heat sink in accordance with another embodiment of the present invention; and

FIG. 14 is a side-view diagram of the multi-fin heat sink of FIG. 13.

FIG. 15 is a diagram of a rocket in a wind tunnel, with a backward facing step created by wrapping duct tape behind the nose cone in order to reduce skin friction drag on the rocket body.

FIG. 16 is a graph showing the coefficient of drag of the rocket of FIG. 15 with airspeed for the untreated rocket, a cone behind the rocket (Flow Control Device-1) and the step of FIG. 15 (Flow Control Device-2).

FIG. 17 is a diagram showing the increase in maximum altitude of the rocket of FIG. 15 (Experimental) when launched vertically versus the same for the untreated rocket (Control).

FIG. 18 is a diagram showing the reduction in the angle of the attached shock wave on the top of a wedge as compared to the bottom when the wedge is exposed to a supercritical flow from the left to the right and the top leading edge has a backward facing step immediately behind it.

FIG. 19a is a section of a streamlined object, such as a wing with a combination of backward and forward facing steps, flow pre-conditioners and deturbulators (FCSD).

FIG. 19b is a diagram depicting the modification of the top surface boundary layer due to the application of deturbulators in accordance to FIG. 19a.

FIG. 20a is a diagram showing the change in non-dimensional surface pressures on a Wortmann airfoil model corresponding to the airfoil at a section of the wing of a Standard Cirrus sailplane, 53-inches outboard from the wing root joint due to a combination of backward and forward facing steps and FCSD deturbulator on the upper surface.

FIG. 20b is a diagram showing the change in the profile of boundary layer mean velocities and rms-velocity fluctuations at 80% of the chord on the suction surface due to the treatment of FIG. 20a.

FIG. 21a is a diagram showing an increase in lift-to-drag ratio of a prototype Standard Cirrus sailplane whose wings have been treated throughout the span similar to FIG. 20a.

FIG. 21b is a diagram showing reduction in induced drag (CDi) of the prototype Standard Cirrus sailplane due to partial span and full span treatments of FIG. 20a.

FIG. 22 is a diagram showing a FCSD Deturbulator strip and triangular shaped flow pre-conditioners installed on the top surface of the GT-3 aircraft wing along with a boundary layer mouse shown on the bottom.

FIG. 23 is a diagram showing changes due to the treatment of FIG. 22 in the measured upper surface boundary layer velocity profiles of the GT-3 wing at 90% of the chord.

FIG. 24 is a diagram showing the reduction in profile drag of a wing section of the GT-3 due to the treatment of FIG. 22.

FIG. 25 is a diagram showing the stabilization of the separated flow region behind a bluff object like a road vehicle due to deturbulator treatment.

FIG. 26 is a diagram of a model car in a wind tunnel treated with a backward facing step on the top behind the windshield using a piece of duct tape.

FIG. 27 is a diagram showing the aerodynamic drag coefficient of the model car of FIG. 26 with a variety of treatment with the deturbulator on the back top as per FIG. 25 showing the largest reduction.

FIG. 28a is a diagram of a 2000 Honda Odyssey EX minivan treated with FCSD strips on the top front and rear and on the sides at the rear corners.

FIG. 28b is a diagram showing a close up of the upper surface FCSD Deturbulators of FIG. 28a.

FIG. 29a is a diagram showing the change in average highway gas mileage of the Honda Odyssey due to the treatment of FIGS. 28a and 28b.

FIG. 29b is a diagram showing the change in average highway and city combined gas mileage of the Honda Odyssey due to the treatment of FIGS. 28a and 28b.

FIG. 29c shows the hypothesized effect of applying Deturbulator strips to a truck cab.

FIG. 29d shows an actual installation.

FIG. 29e also shows a preliminary conceptual sketch of a possible “snap-on” mounting method.

FIG. 29f shows a 1/48 scale model of a Freightliner Columbia tractor with a Van or box trailer as tested in a wind tunnel.

FIG. 29g shows a mounted model.

FIG. 29h shows the final Deturbulator treated truck.

FIG. 29i shows reductions in measured drag for various treatments.

FIGS. 29j and 29k are the plotted outputs from the 3^{rd} order calibration equation yielded the mean velocity in the vertical plane (U²+V²)^{1/2} as well as the rms fluctuating velocity <u′²+v′²>^{1/2}.

FIG. 29l shows the measurement of mean velocities above the trailer at ½ the length of the trailer from the rear shows increase in mean velocities due to Deturbulator application while making the shear layer characterized by high rms-velocity fluctuations thinner.

FIGS. 29m and 29n show means and fluctuating components of velocity for the untreated truck and with two different substrate geometries of the Deturbulator.

FIG. 29o shows the flow transitioning from complete separation (vertical streaks) to full re-attachment or maximum ∂u/∂y|_{wall} (horizontal streaks).

FIG. 29p shows the first successful installation on a tractor trailer truck. 4% increase in overall mpg with 97% significance in t-tests was obtained with Deturbulators on the sides of the cab, top of the cab and top rear of the trailer.

In FIG. 29q, the highway mileage was estimated by subtracting fuel consumed during idling. Idling time was recorded by the truck driver and verified against data downloaded from the truck CPU.

FIG. 29r shows the vinyl strips also had a slight convex curvature.

FIG. 29s shows how by treating the sides of the tractor cab reduces the separation such that the flow is marginally re-attaching near the rear end.

FIG. 29t reflects the average of truck CPU measured trip mpg with zero indicated idling time over 8 to 8.2 mile segments on Briley Parkway, Nashville Tenn. at 65 mph.

FIG. 29u shows long term (1.5 to 3 months average) data downloaded from the CPU of the older operational Freightliner Columbia tractor with a good condition Wabash 53-ft trailer supplied by Empire Express.

FIG. 29v shows a new simplified model.

FIG. 29w shows Deturbulators on a Flatbed hauling Tractor such that the Load on the Open Trailer is buried inside Stagnated Wake of the Tractor.

FIG. 29x shows a photograph of a Slide in insert Deturbulator and its installation on a Flatbed tractor hauling different loads on open trailer

FIG. 29y shows measured Fuel mileage increase and cost savings due to Deturbulators on the tractor of FIG. 29x.

FIG. 29z shows in operation Fuel mileage measurements in flatbed tractor fleet. Initial measurements on one Slide-in Deturbulator treated truck and photo of tractor are shown.

FIG. 29AA shows Enhanced Van trailer Streamlining with Deturbulators. Deturbulators D0 are mounted on tractor sides and trailer front corners to weaken the trailer gap vortices.

FIG. 30 presents a 3-view of Std. Cirrus, a 15 meter test bed sail plane.

FIG. 31 shows a man with the Deturbulator strips mounted on the test Std. Cirrus.

FIG. 32 shows the measured airspeed indicator instrument error data.

FIG. 33 is a chart that represents the flight measured Airspeed System errors.

FIG. 34 shows the averaged sink-rates measured during the 6 deturbulated-wing test flights.

FIG. 35 shows their corresponding L/D ratios.

FIG. 36 shows the averaged sink-rates measured during the selected 3 deturbulated-wing test flights.

FIG. 37 shows their corresponding L/D ratios.

### DETAILED DESCRIPTION

The present invention relates to the use of devices capable of spectrally altering turbulence to reduce flow induced drag, enhance flow induced lift and enhance flow-surface heat transfer without increasing losses.

In the last application it is in the field of heat exchangers, and more particularly to a flexible composite surface for enhancing heat transfer in heat exchanger passages while minimizing the drop in flow pressure. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

Generally, a system and method in accordance with the present invention enhances the transfer of heat in heat exchangers by utilizing a flexible composite surface (FCS). The FCS includes a membrane coupled to a substrate and a plurality of ridges coupled between the membrane and the substrate. Vibratory motion from a flow pressure gradient fluctuation is applied to at least one segment of the membrane. The membrane reflects the vibratory motion from the at least one of its segments to the flow pressure gradient fluctuation. This sustains fluctuations in the flow pressure gradient only around a pre-selected frequency. This helps sustain a thin layer of re-circulating fluid downstream of the FCS over the solid surface, which exchanges heat with the flow. This thin layer allows efficient heat transfer from the solid surface to the flowing fluid without introducing high frictional forces between the fluid and the wall. This allows heat transfer without increasing the pressure drop in the fluid flow passage. To more particularly describe the features of the present invention, refer now to the following description in conjunction with the accompanying figures.

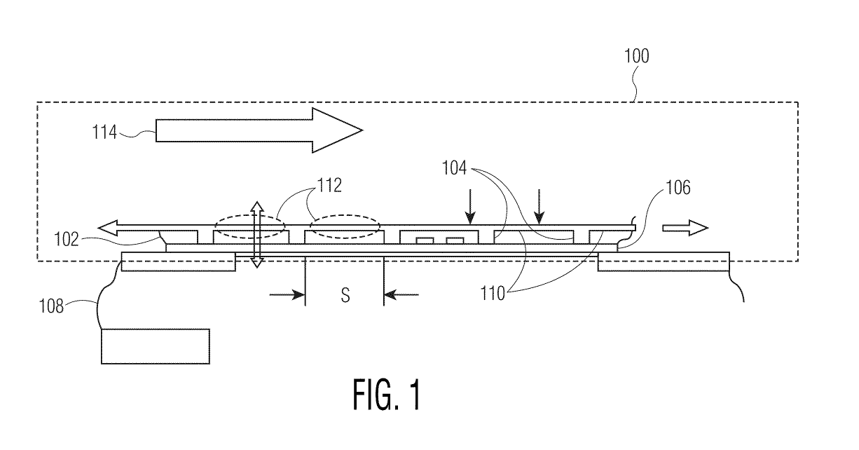

FIG. 1 is a diagram of a flexible composite surface (FCS) 100 in accordance with the present invention. The FCS 100 is also referred to as the SINHA-FCS 100. The FCS includes a flexible membrane 102, which is stretched across an array of strips or ridges 104. The ridges 104 are coupled to a substrate 106. The FCS 100 can be coupled to an aerodynamic body. In this specific embodiment, the FCS 100 is coupled to a surface of a wing 108. Also, the membrane 102 is thinner (e.g., 6 um) than the substrate base (e.g., 50-100 um).

The membrane 102, the ridges 104, and the substrate 106 form air pockets 110 that contribute towards the stiffness and damping governing flexural vibratory motion 112 of the membrane 102. The flexural vibratory motion 112 is caused by the flow 114 of a fluid along the membrane 102.

The natural frequency of the flexural vibratory motion 112 can be tuned as desired by varying the spacing S between the ridges 104, the size (e.g., thickness) of the air pockets, the tension of the membrane 102, as well as the density and elastic modulus of the membrane material (Sinha et al, 1999). The damping of the membrane 102 can be made to vary with frequency and flexural mode by segmenting the air pockets 110 with suitably located shorter ridges. The narrow gap above a short ridge provides an increased resistance to airflow across it. Thus, all flexural modes of the membrane requiring such flows in the substrate have larger damping in comparison to modes that do not. One benefit of the FCS 100 is that it controls the frequency and flexural mode passively, i.e., non-powered.

As will is illustrated in more detail below, the mechanics of the interaction between the FCS 100 and the flow 114 stems from the flow 114 imparting motion to the membrane 102 and vice versa. Even though the full details of such interaction are extremely complex, certain dominant interaction modes can be extracted by properly tailoring the mechanical properties of the membrane 102 in relationship to key features of the flow 114, such as the pressure gradient.

The FCS 100 exploits such a dominant interaction mode for manipulating a varying and adverse-pressure gradient (APG) boundary layer flow. APG flows are those where the imposed pressure tends to oppose the flow. In many instances, this leads to boundary layer flow separation, resulting in large increases in turbulence and flow losses. The present invention decreases the boundary layer flow separation and thus decreases overall turbulence and flow losses. As a result of such manipulation, any turbulence in the flow 114 is controlled and the transfer of momentum, heat, and mass across the APG boundary layer can be decoupled and changed to obtain desired outcomes.

Almost all turbulent frequencies can be controlled or eliminated. Also, a small selected frequency band can be amplified, thereby customizing the spectrum of the turbulent fluctuations. Such a selective modification of the turbulent spectrum is another benefit of the embodiments of the present invention. Another benefit is that the FCS can interact with an inflectional velocity profile downstream of the point of flexible-wall interaction.

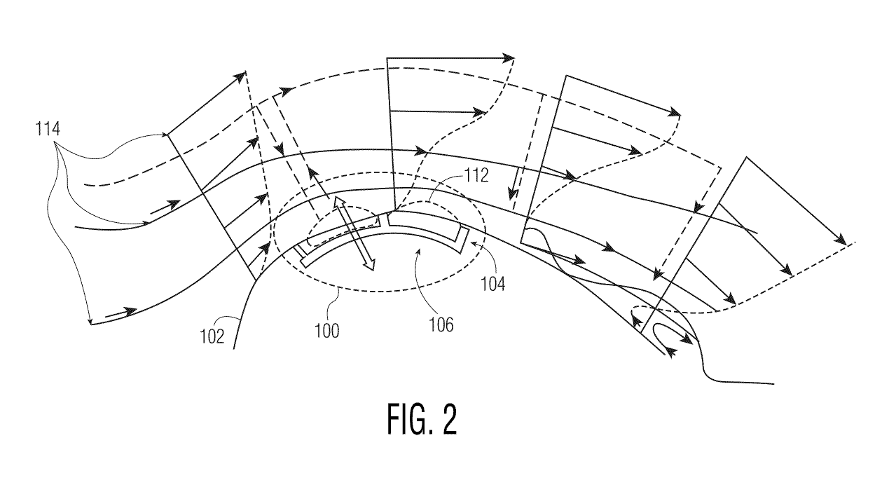

FIG. 2 is a diagram of a portion of the FCS 100 of FIG. 1 interacting with a flow 114 of fluid in accordance with the present invention. The FCS 100 can be located over regions of an aerodynamic surface where the flow pressure gradient changes from favorable to adverse. Under such flow conditions, flow induced pressure fluctuations can impart flexural vibratory motion 112 to segments of the membrane 102 between adjacent ridges 104. The flexural vibratory motion 112 of the membrane segments, in turn, can impart pressure fluctuations to the flow 114 at the vibrating frequencies. This interaction constrains the pressure fluctuations and the resulting flow velocity fluctuations around a frequency f≈U/s (where, U=the freestream velocity above the membrane and s=the distance between adjacent high ridges on the substrate), as long as f does not coincide with the fundamental flexural natural frequency of the vibrating membrane segment.

The exposed surface of the membrane 102 creates a non-zero wall velocity condition for the boundary layer flow at locations where the flow 114 is receptive to this condition. The interaction of the flow 114 with the flexural vibratory motion 112 of the compliant membrane 102 results in the flow 114 being forced to a new equilibrium.

The following description elucidates details crucial towards exploiting this interaction. The streamwise u-momentum equation of the flow 114 at the mean equilibrium position (y=0) of the surface of the membrane 102 of the FCS 100 is considered first:

v(∂u/∂y)y=0=−(1/ρ)(∂p/∂x)+(μ/ρ)(∂2u/∂y2)y=0 (1)

The streamwise x-component of velocity “u” of the vibrating membrane 102 (or the velocity of the fluid at the points of contact with the membrane 102) has been assumed to be negligible, while the wall-normal y-component of velocity “v” of the fluid next to the membrane 102 is clearly non-zero due to membrane compliance. Key to flow-membrane interaction is the realization that the wall-normal gradient of the streamwise velocity at the wall, (∂u/∂y)y=0, can be extremely large at certain x-locations. At such locations, even a small oscillation velocity (v<<U) of the flexible membrane can make the v(∂u/∂y)y=0 “control” term on the left hand side of equation (1) predominant. For a non-porous, non-compliant wall, this control term is identically zero. Additionally, if the boundary layer velocity profile at the aforementioned locations is such that prior to interaction (∂2u/∂y2)y=0≈0, while |(∂u/∂y)y=0|>0, (i.e., u(y) is approximately linear near the wall) an order of magnitude balance of the terms in equation (1) yields:

v(∂u/∂y)y=0≈−(1/ρ)(∂p/∂x) (1-a)

Such a condition can be satisfied in boundary layers over curved surfaces, in the vicinity of x-locations where the streamwise pressure gradient ∂p/∂x changes from favorable (∂p/∂x<0) to adverse (∂p/∂x>0), as shown in FIGS. 1 and 2. What makes such locations unique is the large relative change in ∂p/∂x introduced through equation (1-a), since ∂p/∂x≈0 prior to this interaction.

For boundary layer flows, pressure variation across the boundary layer (∂p/∂y) is negligible, and the streamwise pressure gradient ∂p/∂x can be obtained from the inviscid momentum equation at the outer, or freestream edge of the boundary layer:

(∂U/∂t)+U(∂U/∂x)=−(1/ρ)(∂p/∂x) (2)

For x-locations where equation (1-a) holds, an oscillatory motion of the wall can, therefore, directly introduce fluctuations in the freestream velocity U, through the pressure gradient term. For example, in a steady boundary layer flow over a rigid non-porous wall, the pressure gradient term on the right hand side of equation (2) will be completely balanced by the non-linear convective term [U(∂U/∂x)] on the left hand side. If this flow is perturbed, by introducing a small wall-normal velocity v through flexible wall motion, the resulting fluctuations in the pressure gradient will have to be balanced by the unsteady term (∂U/∂t) in equation (2). For x-locations where ∂p/∂x≈0 in the un-modified flow, as required for ensuring the validity of equation (1-a), the overall effect of wall motion can be expressed as:

∂U/∂t≈v(∂u/∂y)y=0 (3)

It is important to note that equation (3) holds irrespective of the source of the perturbations. The discussions thus far have presumed the source to the flexible wall (Sinha, 2001). However, equation (3) also describes how fluctuations in the freestream velocity U can impart oscillations to a compliant wall at x-locations where equation (1-a) remains valid (Sinha and Zou, 2000). If fluctuations exist in the freestream velocity U, as is normally the case in most external aerodynamic flows, the presence of a compliant wall around the ∂p/∂x≈0 location results in partitioning the energy of the fluctuations between the fluid and the wall (Carpenter et al, 2001). The degree of partitioning at any instant depends on the temporal phase of the wall oscillation cycle.

The vibratory response of the wall also plays a key role in this interaction. The predominant response of the FCS 100 can be expected to be flexural. The maximum displacements and energy storage capacity of the FCS 100 corresponds to the fundamental mode as per the sketch of the deflected membrane in FIGS. 1 and 2. Dissipation can also be expected to be higher for higher modes of flexural vibratory motion, especially if the low ridges constrict the airflow across them.

The combined flow-wall interaction proceeds as follows: As a mass of disturbed freestream fluid approaches a segment of the membrane 102, where equation (1-a) holds, the membrane 102 begins to undergo flexural displacement. The membrane 102 continues to deflect as the disturbed fluid convects over it. At some point the displaced membrane 102 begins to swing back, initiating the reverse phase of the oscillation cycle. In the process of deflecting to its extreme position, the membrane 102 and substrate 106 of the FCS 100 store a significant portion of the flow fluctuation kinetic energy as elastic potential energy. As the membrane 102 springs back, most of this energy is released back to the flow 114. However, the original fluid particles, which had provided this energy, would have convected downstream by a distance U·Δt during the time interval Δt taken by the membrane 102 to execute one oscillation cycle. For the re-released energy to be imparted to the same mass of fluid that originated it, the following condition must hold:

U·Δt=s (4)

where, s=the free length of the membrane of the FCS 100, between two ridges.

This condition imposes the membrane oscillation frequency: f=U/s. The aforementioned process results in amplifying fluctuations corresponding to f, while attenuating fluctuations at other frequencies. The efficacy of the selection process depends on the ability of the FCS to damp out higher modes, while minimizing damping in the fundamental flexural mode. Also, the spacing s has to be sufficiently close such that equations (1-a) and (3) hold throughout this region. The frequency selection criterion and the conditions needed for small amplitude wall motion to influence the freestream also hold for externally actuated active flexible wall transducers (Sinha, 1999 and Sinha, 2001). The validity of equation (3) has been experimentally verified by noting the fact that electrically driven flexible wall motion at a frequency f=U/s produced large fluctuations in the freestream velocity U at the same frequency while attenuating fluctuations at other frequencies (Sinha, 2001).

The net effect of the aforementioned selection process is to concentrate velocity and pressure fluctuations at a frequency f≈U/s. Also, these fluctuations convect downstream to the point where the boundary layer begins to separate. At the separation point, equation (1) simplifies to:

0=−(1/ρ)(∂p/∂x)+(μ/ρ)(∂2u/∂y2)y=0 (5)

This implies that fluctuations in a ∂p/∂x directly contribute towards introducing a vorticity flux ∂Ω/∂y=∂(∂u/∂y)/∂y through the viscous term in equation (5). Also, equations (1-a) and (3) hold on the centerline of the separated shear layer, immediately downstream of the separation point. The final effect is to utilize sustained fluctuations in the freestream velocity U to impart wall-normal oscillations at a predetermined frequency U/s to the separated shear layer, thereby encouraging rapid entrainment of the surrounding fluid through wave breaking. Increased entrainment from the separated region near the wall reduces the pressure in this region and forces the separated shear layer closer to the wall. This results in reattachment of the flow.

Compared to the unmodified flow, the FCS 100 constrains turbulent fluctuations to a narrower band. This “customized turbulence” can be expected to be less dissipative. The fundamental natural frequency for flexural vibratory motions 112 of the membrane 102 has no bearing on the flow-membrane interaction frequency f, as long as they are sufficiently apart. If the two coincide, the amplitude of the oscillating membrane 102 increases, thereby enhancing non-linear dynamic effects. This can trigger other modes of oscillation of the membrane 102, thereby increasing energy losses and broadening the spectrum of flow fluctuations. The FCS 100 then begins to behave as a broad-spectrum turbulator, promoting much larger losses through rapid buildup of turbulent skin friction.

One of the features of the FCS 100 is control of boundary layer flows in general, including applications to aircraft wings. The FCS 100 can be applied to an aircraft wing to achieve drag reduction. In order to ascertain the feasibility of using the FCS 100 to reduce wing drag flight tests were conducted with an FCS tape (with 0.4 mm-wide high strips with spacing s=0.8 mm and a single 15-μm lower low strip in the center of each pair of high strips) mounted at about 65-75% of a chord from a leading edge on the top (suction) and bottom (pressure) surfaces of an advanced 1.24-m chord.

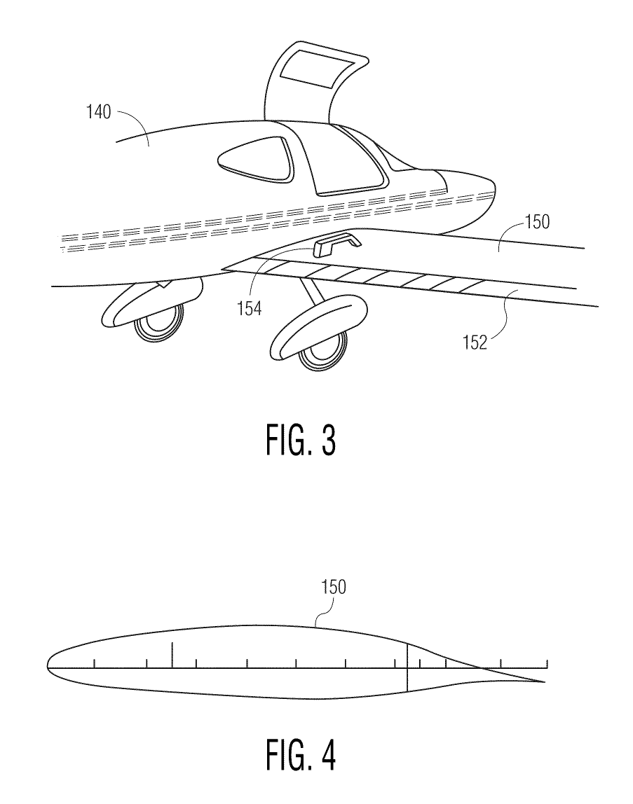

FIG. 3 shows a photograph of a Global-GT3 test aircraft 140 (manufactured by Global Aircraft Inc., Starkville, Miss.), which is instrumented for wing-bottom measurements. The aircraft 140 has a wing 150, which is used for the wing drag flight tests. The wing 150 has a starboard flap 152. Pressure transducer array 154 is mounted on top of the wing 150.

FIG. 4 is a diagram showing the cross-section of the wing 150 of FIG. 3. In this specific embodiment, the wing 150 is an NLF-0414F natural laminar-flow airfoil wing. The flow pressure gradient changes from slightly favorable to adverse around 65-75% of the chord on both the top (suction) and bottom (pressure) surfaces of this airfoil.

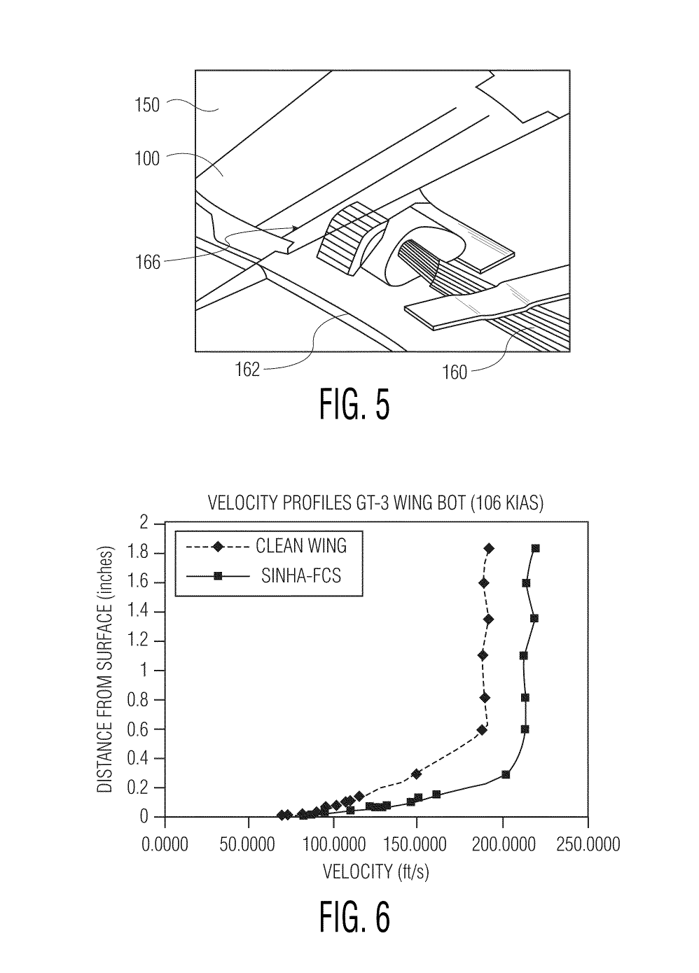

FIG. 5 shows a photograph of a SINHA-FCS 100 mounted on the bottom of the wing 150 of FIG. 3, along with the boundary layer mouse 160 used to measure boundary layer velocity profiles. This arrangement is just below the outboard end of the taped section of the starboard flap 152 of FIG. 3. In this specific application, the FCS 100 is a 300-mm spanwise and 50-mm chordwise section. A wing-flap joint 162 runs over the mouse 160. The leading edge of mouse tubes 166 are immediately upstream of the wing-flap joint 164 at x/c=0.8.

During the test, the aircraft was flown at about 3000 ft pressure altitude at its level cruising speed of 106-kt. This corresponded to Rec≅4.8×10⁶, flight Mach number M≅0.22 and a section angle of attack α≅−1°. Several sets of data were acquired both for the clean airplane without the FCS 100, as well as with the FCS 100.

FIG. 6 is a chart showing measured pressure-side boundary-layer velocity profiles at 80% of chord from the leading edge, with and without the SINHA-FCS. Integrating the velocity profiles shows the drag resulting from the marginal separation induced wake momentum defect as: Fractional reduction in drag=[∫ρu2dy| with FCS−∫ρu2dy| clean wing]/∫ρu2dy| clean wing. The data in FIG. 6 showed that the FCS reduced the drag under level cruise conditions by about 25%.

A significant increase in the freestream velocity is also seen due to the FCS. This could not be attributed to measurement uncertainties. The FCS, therefore, also helps speed up the flow outside the viscous dominated boundary layer. As expected for a lifting wing, at x/c=0.8, the freestream velocities on the suction side are higher than those on the pressure side. However the difference is smaller for the data with the FCS. Hence, it is possible for the FCS to influence CL as well.

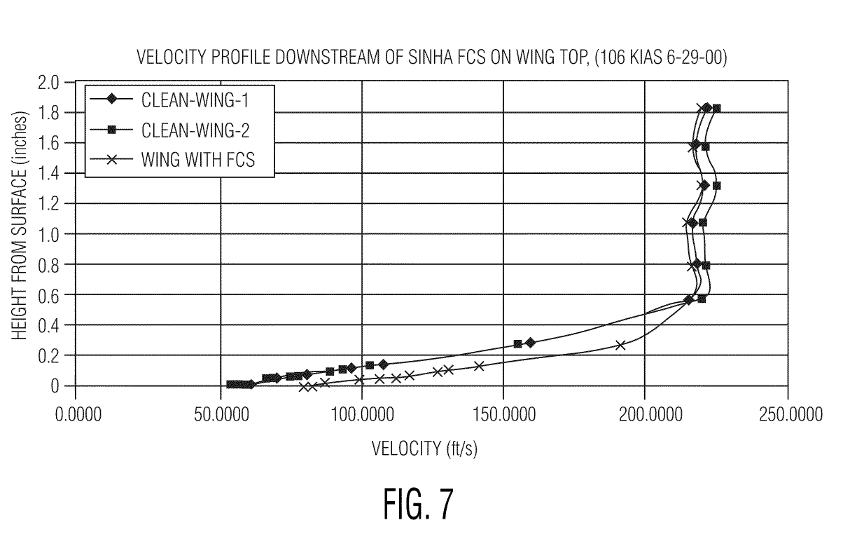

FIG. 7 is a chart showing measured suction-side boundary-layer velocity profiles, with and without the SINHA-FCS at 80% of chord from the leading edge. The difference between Clean-Wing-1 and Clean-Wing-2 profiles shows test uncertainties. FIG. 7 shows a similar behavior for the suction side of the wing, resulting in 18-20% reduction in drag. The two “Clean-Wing” profiles, corresponding to the extreme values of the measured velocity profiles, provide a visual indication of uncertainties in the acquired data due to unavoidable atmospheric turbulence. Based on the aforementioned estimates from this data, approximately 20% reduction in wing drag can be expected for the section of the wing influenced by the FCS if it is affixed to both top and bottom surfaces.

The data of FIGS. 6 and 7 were obtained by affixing the FCS strip first to the pressure side only and then to the suction side only. If the FCS were applied to cover substantial spanwise locations on both surfaces, the wing angle of attack and the throttle setting would probably have to be changed to maintain the constant 106-kt airspeed.

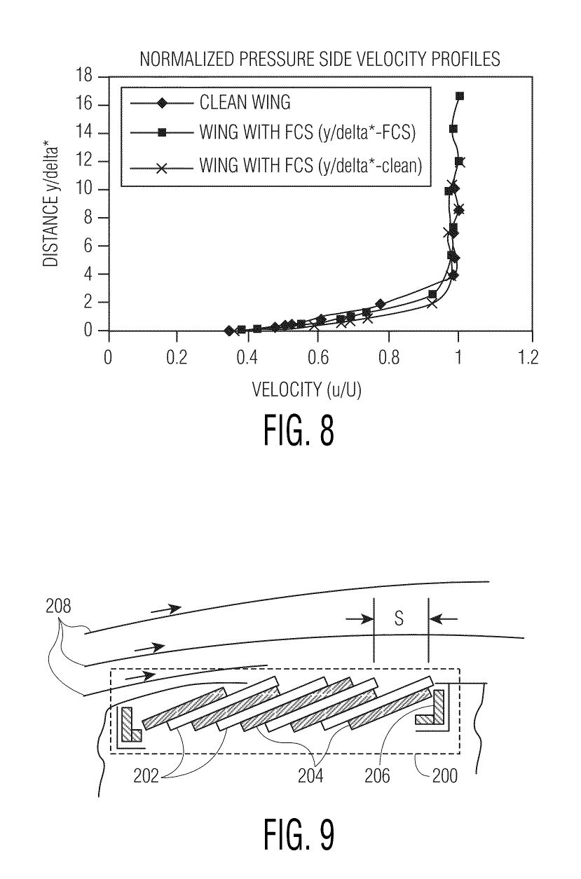

FIG. 8 is a chart showing plots of the pressure-side velocity data of FIG. 6 normalized with respect to the measured velocities furthest away from the wall. The profiles for the wing with FCS are normalized with respect to δ* values before and after FCS application. This isolates the change in the shape of the velocity profile. FIG. 8 demonstrates that applying the FCS on the bottom surface reduces the shape factor H (H=displacement thickness δ*/momentum thickness θ) from 1.46 to 1.35, thereby making it fuller.

FIG. 9 is a diagram of an FCS 200 interacting with a flow of fluid in accordance with an embodiment of the present invention. This embodiment consists of thin plates 202 staggered at a shallow angle and sandwiched between compliant porous elastomeric layers 204 having visco-elastic properties. This assembly is imbedded in a substrate 206, which can be affixed to a body over which an adverse-pressure-gradient flow 208 takes place.

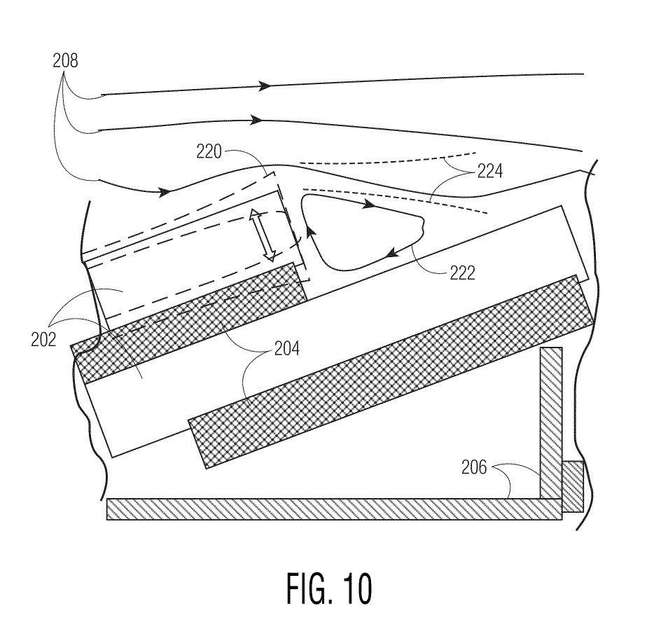

FIG. 10 is a blow-up diagram of a portion of the FCS 200 of FIG. 9 interacting with a flow of fluid in accordance with another embodiment of the present invention. The tips 220 of the plates 202 are exposed to a locally varying pressure gradient, changing from favorable upstream to adverse downstream. In a manner similar to the previous embodiment, the tips 220 will experience flow-induced oscillations, since the flow pressure gradient exactly over it will be zero. The flow 208 will separate downstream of the tips 220 entrapping a small vortex 222. Due to the damping provided by the compliant layers 204, most of the turbulent kinetic energy imparted to the plates 202 will be dissipated. However, in a manner similar to the previous embodiment, flow-induced oscillations around the frequency f≈U/s (U=the local freestream velocity of the flow 208, and s=streamwise spacing of the plate tips 220) will be allowed to pass. This will control the entrainment in a shear layer 224.

In the ideal case, the vortex 222 should extend just up to the tip 220 of the plate 202 immediately downstream. A larger vortex 222 will cause full-blown flow separation with an accompanying large increase in form or pressure drag. Whereas, a small vortex 222, due to excessive entrainment in the shear layer 224, will increase the skin friction drag. A reduction in skin friction occurs due to the reversed flow next to the surface of the plates 202 caused by the vortex 222. The choice of the compliant porous elastomeric layer has to be such that its damping increases significantly for oscillation frequencies greater than 2 f.

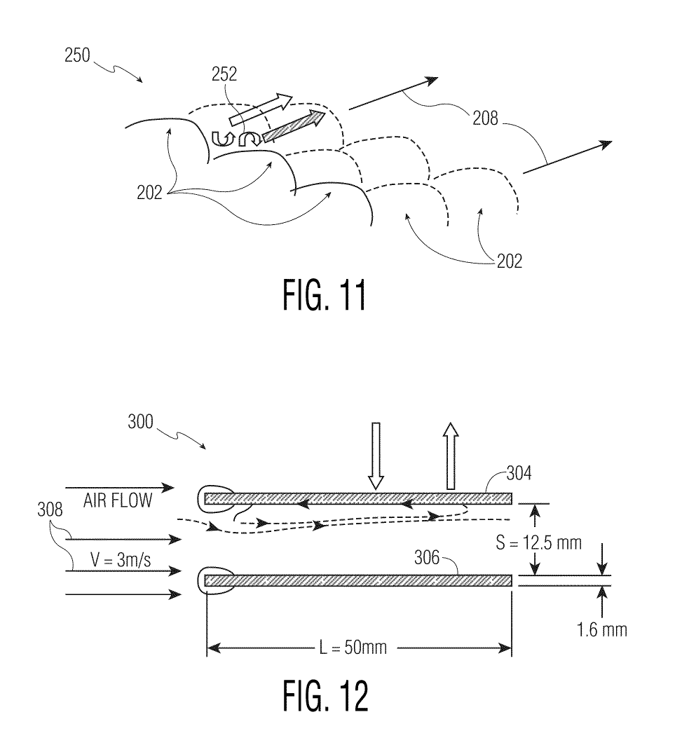

FIG. 11 is a diagram of an FCS 250 interacting with a flow of fluid in accordance with another embodiment of the present invention. In this specific embodiment, the plates 202 have a curved profile giving and form a fish-scale pattern. As such, counter-rotating longitudinal vortices 252 can be generated that can assist in drawing the shear layer closer to the surface of the plates 202 by enhancing mixing.

FIG. 12 is a diagram of a heat transfer enhancement test apparatus 300 in accordance with another embodiment of the present invention. The heat transfer enhancement test apparatus 300 includes an FCS 302, which is wrapped around the leading edges of heat exchanger fins 304 and 306. In this specific embodiment, the heat exchanger fins 304 and 306 are 250 mm wide.

A 3-m/s approach velocity of ambient atmospheric air 308 through a 12.5-mm wide fin passage was used while the upper heat exchanger fin 304 was heated or cooled. The heat transfer coefficients were deduced from direct measurement of fin surface heat flux and air temperatures. The passage pressure drop is between the ambient air and exit of the passage. Application of the FCS 302 was seen to reduce the pressure drop by about 32% while increasing fin surface heat transfer coefficients between 43% and 127%. The FCS 302 achieves this by destroying the similarity of temperature and velocity profiles (i.e., Reynolds analogy) through the sustenance of a thin vortex 310, through turbulence spectrum modification, near the fin surface. Heat flows easily across this vortex, which also allows the main flow through the passage to proceed unabated as compared to the clean fin surface. The following illustrates heat transfer characteristics with and without the FCS 302.

| CLEAN FINS (No FCS) | FINS WITH FCS |
|---|---|
| Pressure Drop along 50-mm passage: | (ΔP) = 10.9 ± 0.1 Pa |
| (ΔP) = 16.0 ± 0.1 Pa | |
| Average Heat Transfer Coeft (Top Heated): | h = 55.5 ± 1.7 W/m²-K |
| h = 38.7 ± 1.2 W/m²-K | |
| Average Heat Transfer Coeft (Top Cooled): | h = 42.0 ± 5.5 W/m²-K |
| h = 18.5 ± 4.0 W/m²-K | |

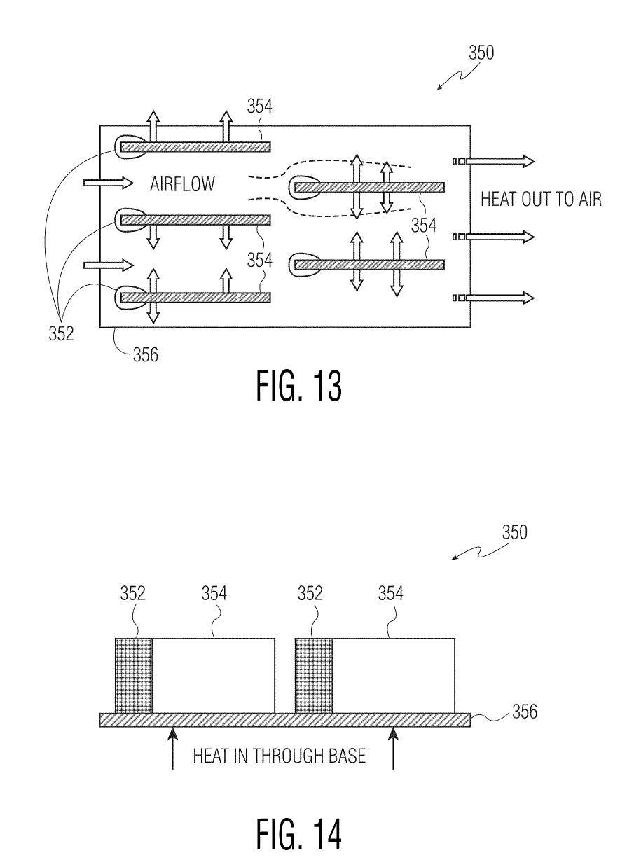

FIG. 13 is a top-view diagram of a multi-fin heat sink 350 in accordance with another embodiment of the present invention. The multi-fin heat sink 350 includes an FCS 352, which is wrapped around heat exchanger fins 354. The heat exchanger fins 354 are coupled to a base 356. In operation, heat transfer from the fins to a fluid, or vice-versa, is enhanced, while reducing the fin-passage pressure drop in the fluid.

FIG. 14 is a side-view diagram of the multi-fin heat sink 350 of FIG. 13. The FCS-enhanced fins 354 can be configured into a multi-fin heat exchanger in a variety of ways. For example, the fins can be staggered as shown in FIG. 13. The fins 354 can form a plurality of flow passages. The flow passages can be parallel. The principal flow through the flow passages can also have a component parallel to the local gravitational field thereby creating a compact natural convection surface. In another embodiment, the FCS can be coupled to fins on a heat pipe, fins on a tube carrying a hot or cold heat transfer fluid, or to the leading edge of one or more blades of a fan.

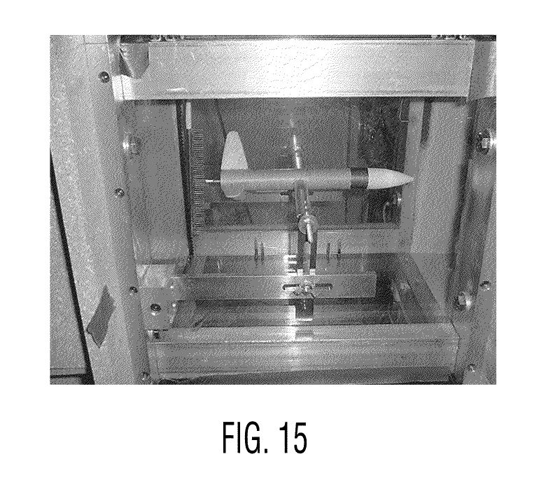

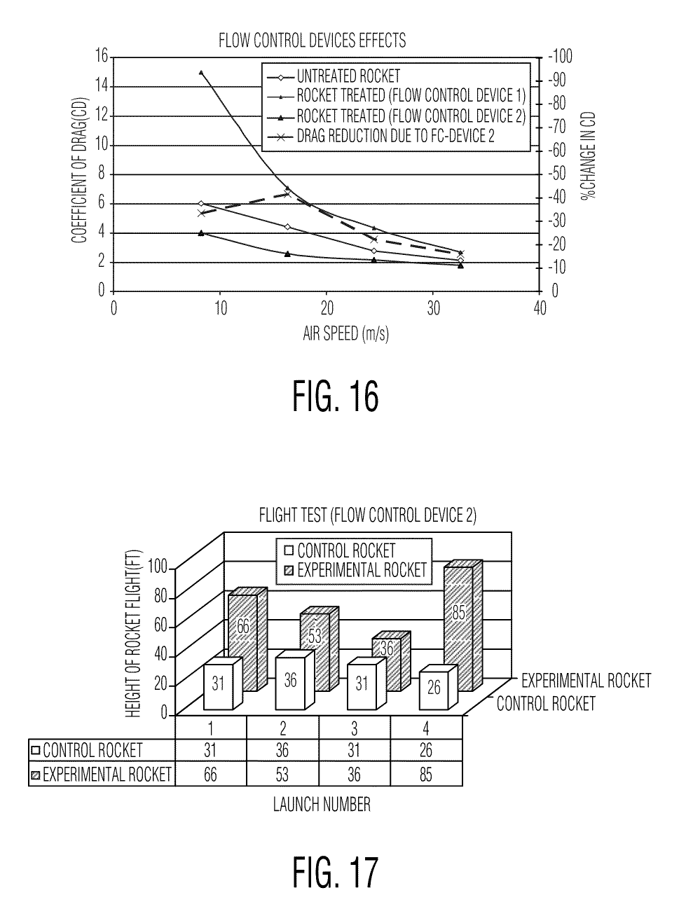

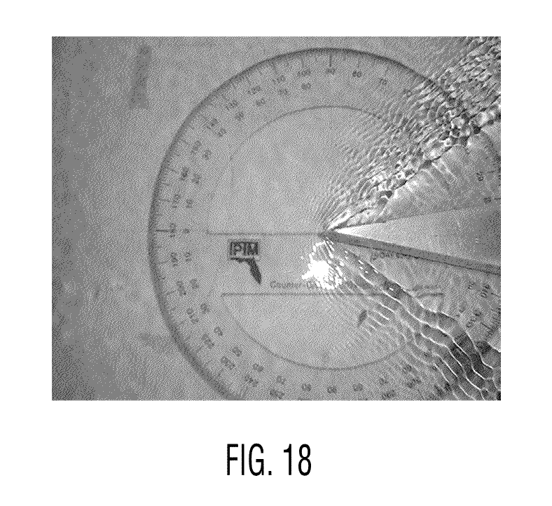

Skin friction drag can be reduced by lifting the boundary layer off the wall by a small amount using a backward facing step to intentionally promote separation behind it, as demonstrated by a 70-μm thick duct tape wrapped around a model rocket immediately behind its nose cone (FIG. 15). The coefficient of drag CD deduced from the total pressure difference between the front and rear of the rocket measured by the averaging drag rake in FIG. 15 is shown in FIG. 16. The reduction in drag increases the maximum altitude of the rocket when it is launched (FIG. 17). The reduction in skin friction behind the step can also be used to reduce drag in supersonic flows as demonstrated by the reduced angle of the shock waves at the leading edge of a wedge in an analogous situation of free surface water flow (FIG. 18).

The drag reduction with a backward facing step however comes down with increasing speed (FIG. 16). Increase in speed causes the Reynolds number to increase culminating in transition to turbulence behind the step which causes the slightly separated flow to reattach and increase skin friction. Hence an appropriately placed de-turbulator is needed to attenuate turbulence. A deturbulator is a surface mounted device that interacts with the flow boundary by means such as passive or active flow-induced compliant wall motion (FIG. 1), flow induced motion of nano-fibers or other forms of surface mounted compliant or porous structures, electromagnetic forces, motion of trapped vortices due to modified surface texture or geometry or other types of turbulent kinetic energy dissipation or turbulence spectrum modifiers. The preferred device is a flexible composite surface deturbulator of FIG. 1, which only allows a selected single frequency f=U/s to exist in the de-turbulated flow.

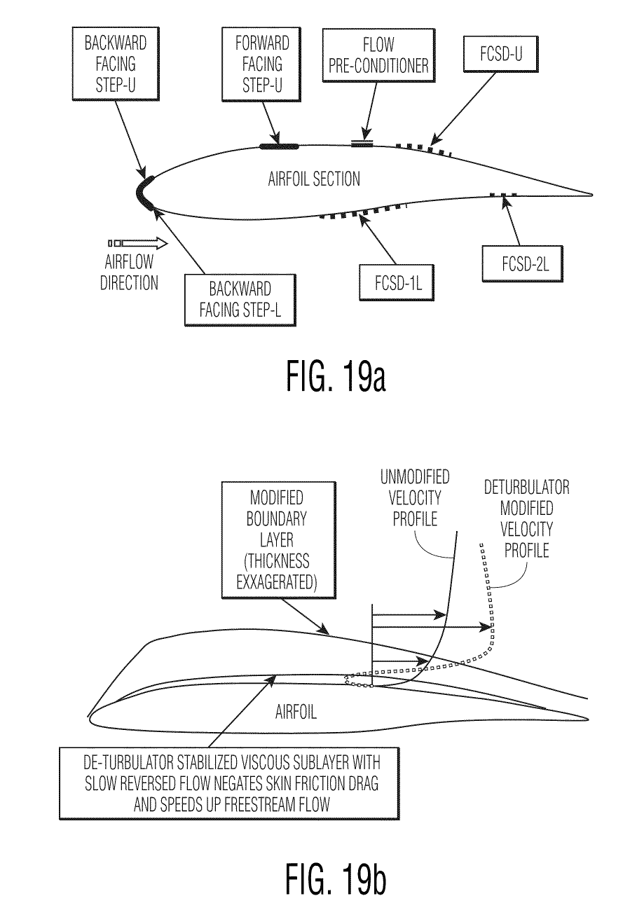

FIG. 19a shows the integration of a FCSD with backward and forward facing steps, The forward facing step enhances the formation of the separated flow behind the forward facing step by preventing the thin layer of nearly stagnant fluid near the wall from sliding downstream. The FCSD by itself has been known to create stable thin layers of separated flow in adverse pressure gradients typical in the aft regions of streamlined objects (Sinha 2001) resulting in lowering skin friction without increasing form drag as shown in FIG. 19b. By integrating the FCSD with the forward and backward facing steps this effect is extended to favorable pressure gradient regions typical in the forward section of streamlined objects. As a result skin friction is reduced across almost the entire surface of a streamlined object.

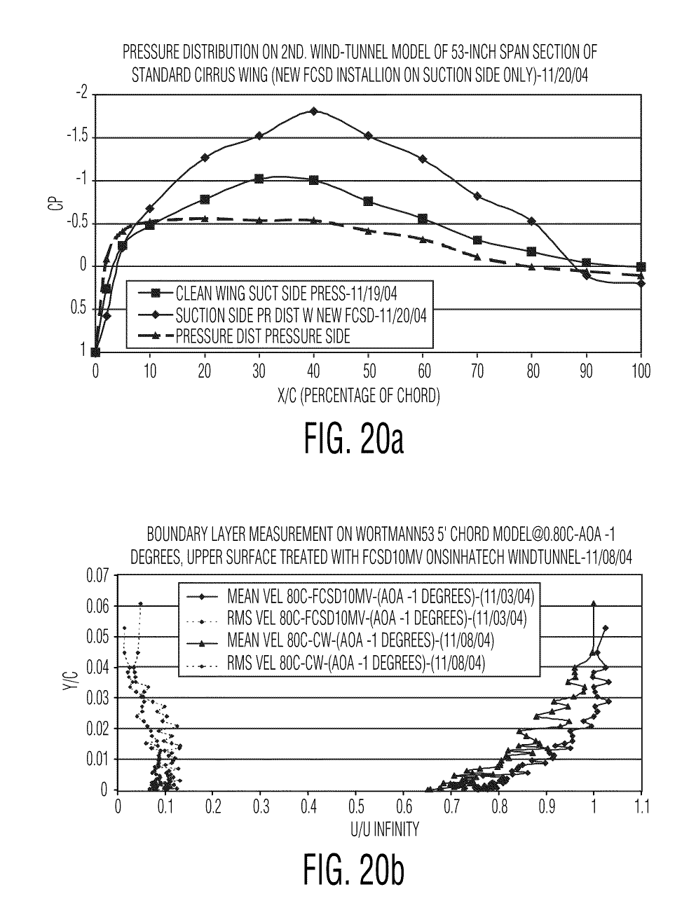

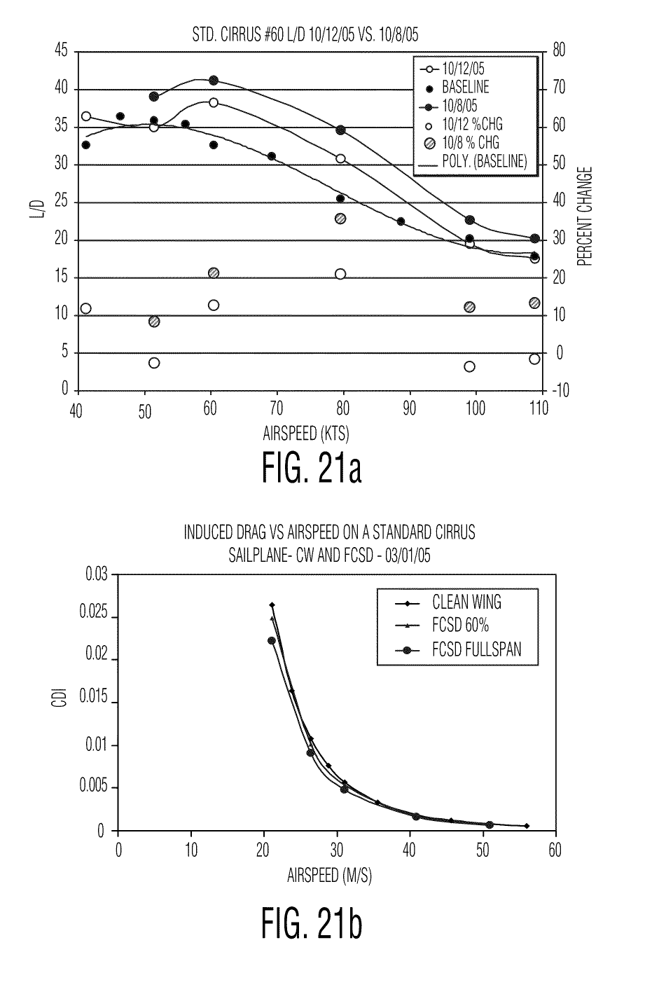

Reducing skin friction in the aforementioned manner also speeds up the inviscid freestream flow outside the boundary layer. This is because the nearly stagnant layer next to the solid surface is seen as a slip layer by the inviscid flow which unlike a normal viscous boundary layer does not try to slow it down. When the treatment is applied to the upper surface of a lifting body, such as a wing, the higher speed inviscid flow lowers the pressure. This helps increase lift as shown in the measured pressure distributions of FIG. 20a for a Wortmann airfoil section, representing the airfoil 53-inch outboard from the wing root joint of a Standard Cirrus sailplane. FIG. 20b shows the de-turbulation effect as a reduction in velocity fluctuations while the mean velocity profile is made fuller. The tests were run at Reynolds number Re=0.3-million, Mach number M=0.09 and a section angle of attack of −1°. The increase in lift means that the wing has to fly at a lower angle of attack at a given airspeed, reducing the forward component of the resultant pressure induced force. This reduces the lift-induced drag (commonly referred to as induced drag) of the wing. Since increase in lift occurs along with reduced drag (including skin friction, form drag and induced drag), the lift to drag ratio of the airfoil section and entire wing increase. This was demonstrated during in-flight sink rate measurements of the Standard Cirrus sailplane, whose wings were subject to the treatment described above over extended regions of the span (FIG. 21a). A 5-20% increase in L/D (Lift to drag ratio) of the entire sailplane is seen across a very broad airspeed range, representing chord based Re from 0.5 to 3 million, M less than 0.23 and angles of attack from −3° to 5°. A reduction in induced drag due to the above treatment is also seen in FIG. 21b.

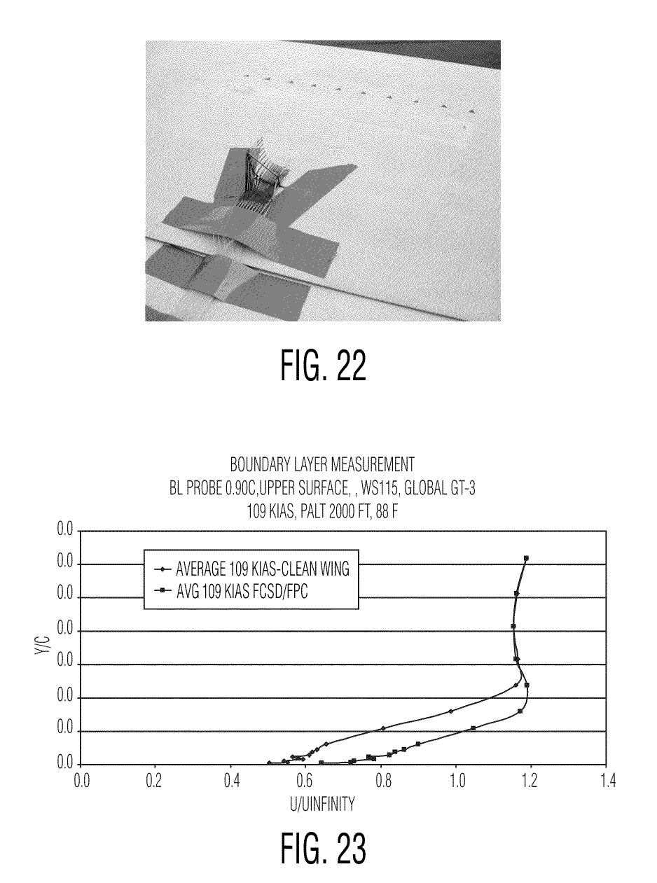

In cases where the adverse pressure gradient is excessive due to a rapid narrowing down of the aft end of a streamlined body, the flow tends to separate and separation induced form or pressure drag is of primary concern. This situation can be mitigated by using an array of flow pre-conditioners (FPC) immediately upstream of the deturbulator. These pre-conditioners are low profile (30-70 μm high) triangular, rectangular or other shapes typically buried in the lowermost layers of the boundary layer. These introduce a slight spanwise variation in the near wall flow. Such a variation impacts the magnitude of wall-normal velocities resulting from an interaction of the FCSD with the boundary layer flow. This encourages the formation of streamwise vortices that aid in transferring momentum from the higher velocity fluid particles at the outer edges of the boundary layer to the slow moving wall layers. As opposed to the traditional practice of using larger height vortex generating structures, this arrangement minimizes undesirable blockage of the flow and turbulent dissipation due to large height devices. FIG. 22 shows an installation of FPC and FCSD on the top surface of the GT-3 aircraft (FIG. 3) wing. FIG. 23 shows the measured velocity profiles at 90% chord. FIG. 24 shows the reduction in profile drag of the NLF-0414F airfoil section of this wing due to combined upper and lower surface treatment with FPC-FCSD.

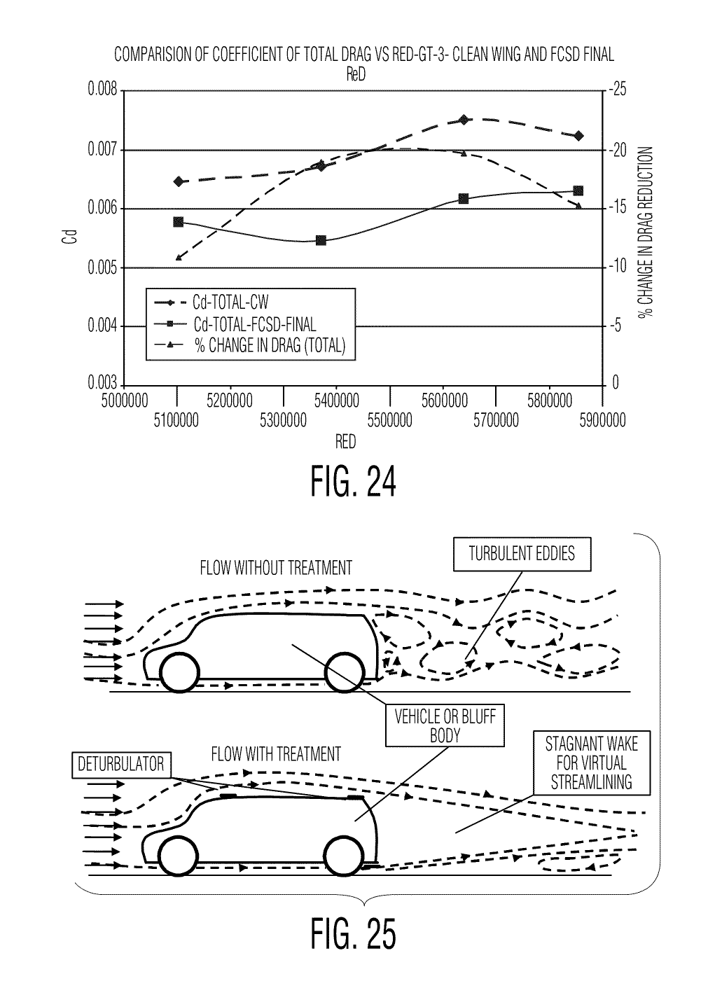

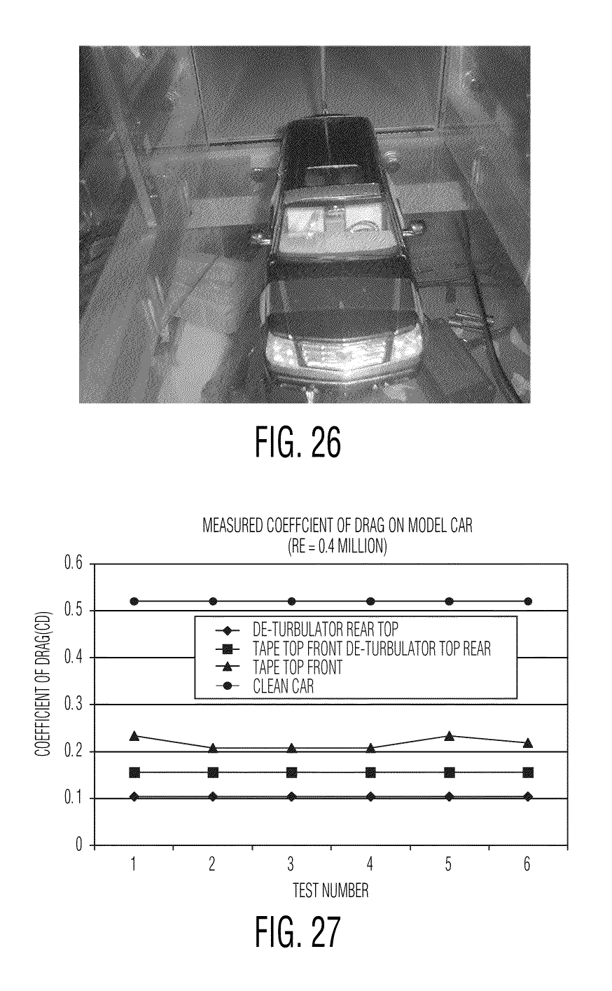

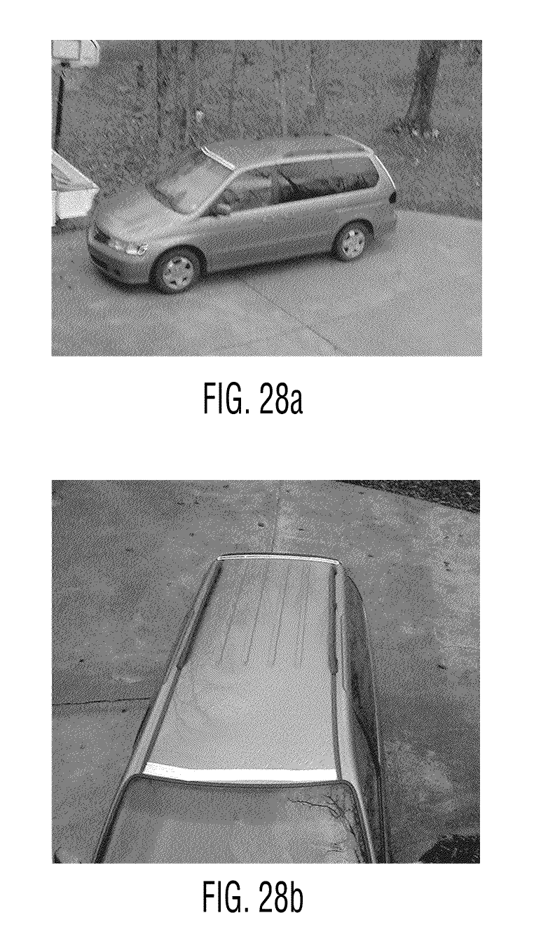

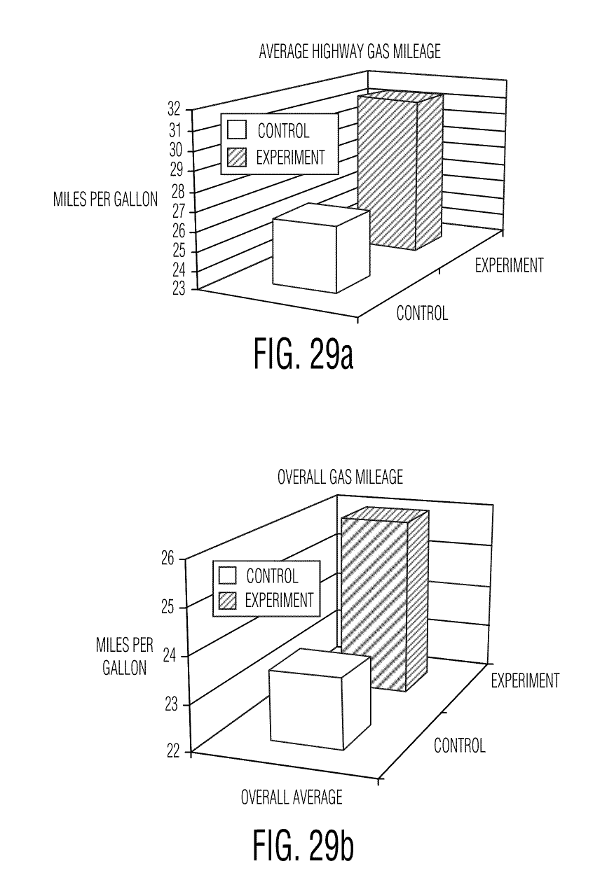

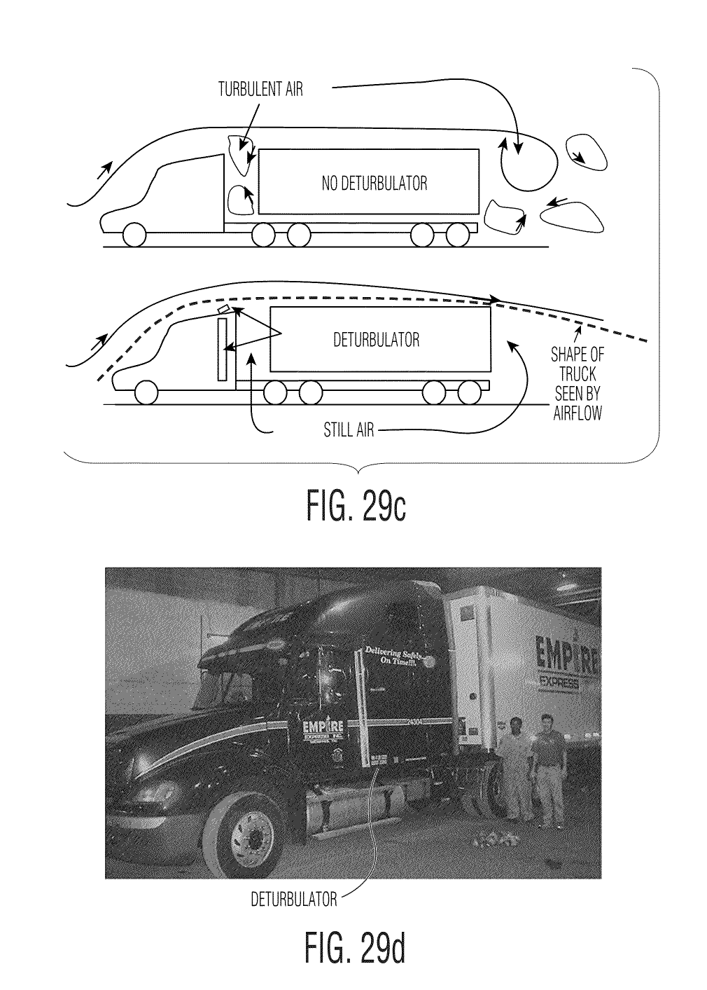

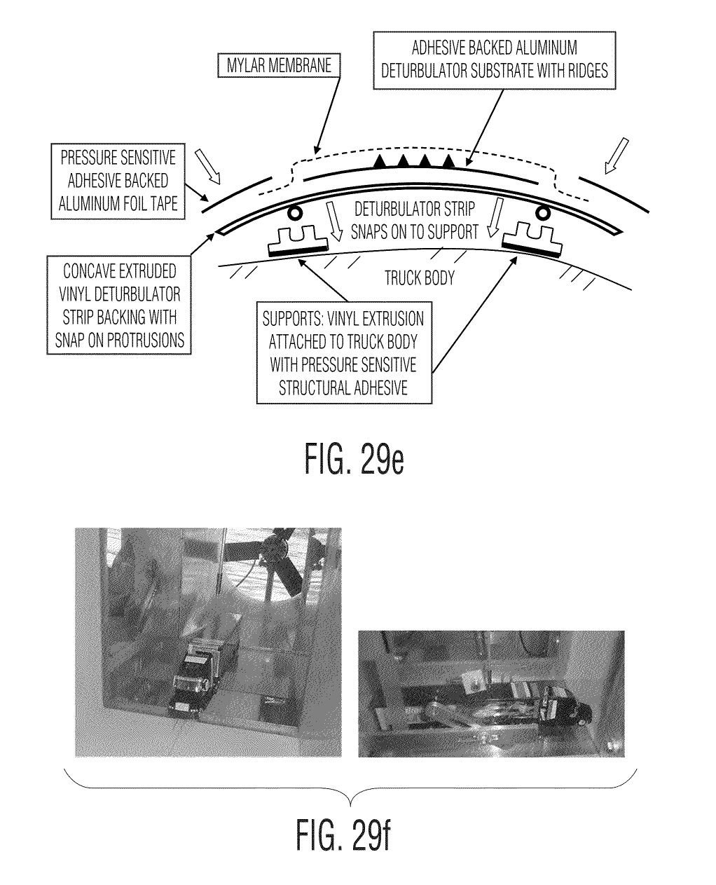

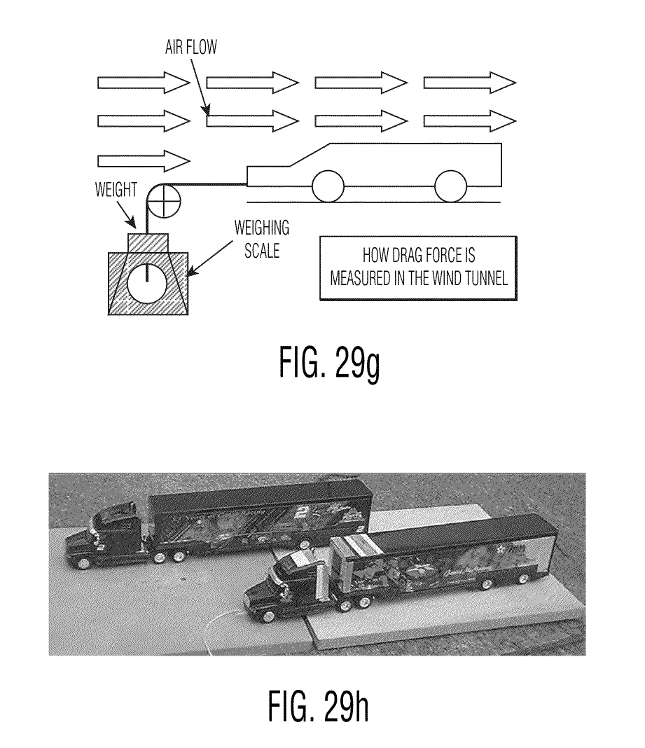

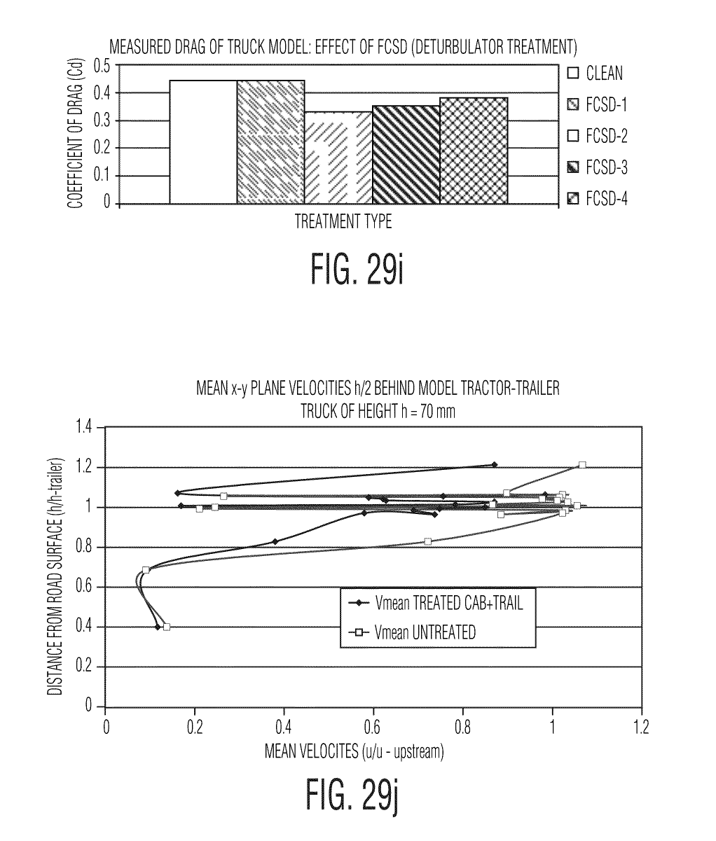

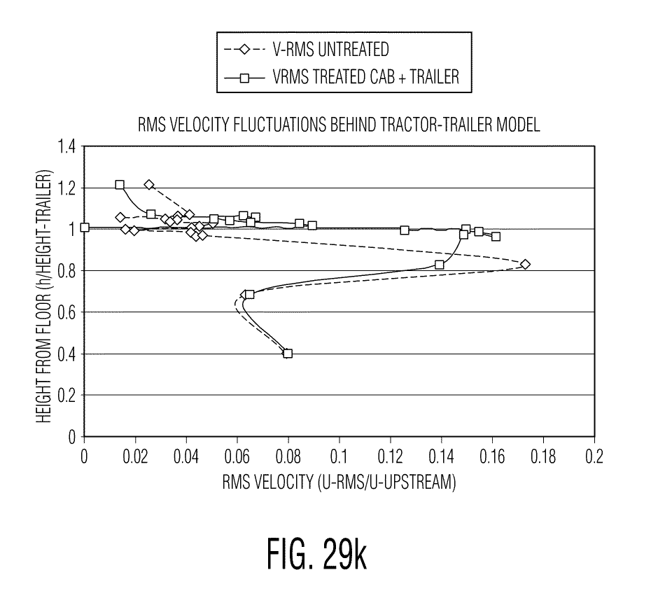

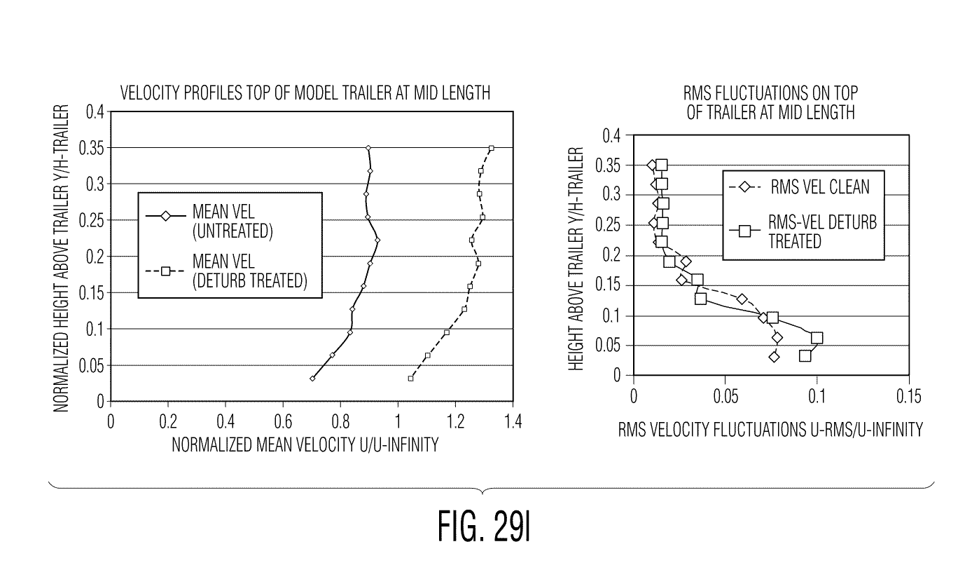

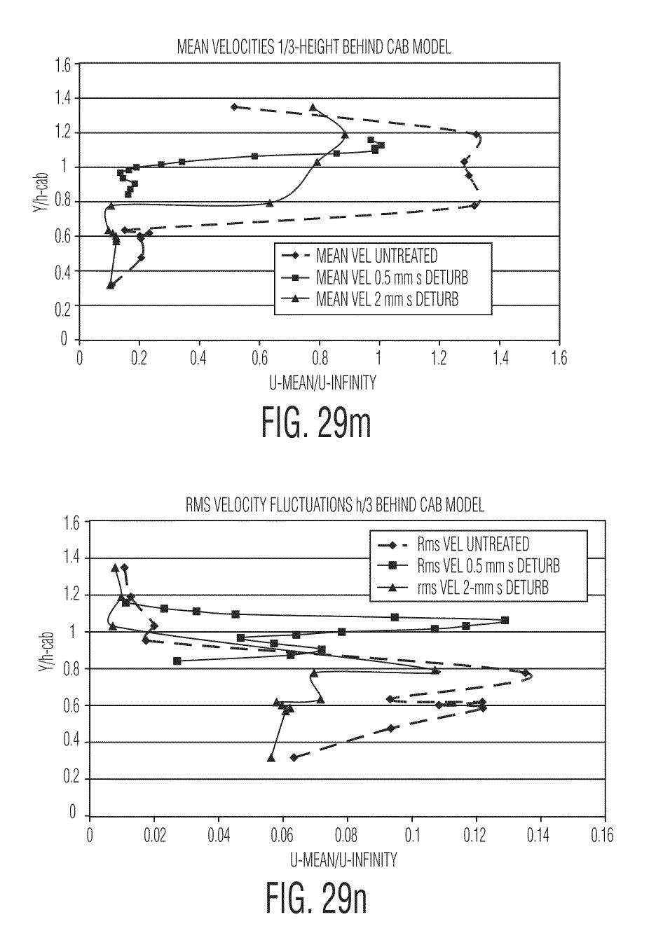

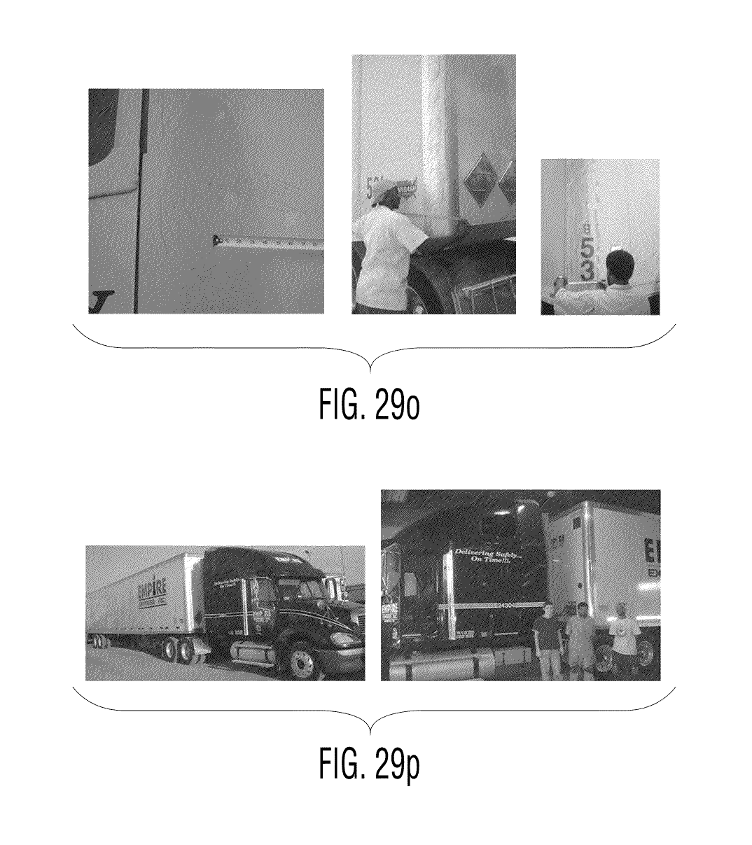

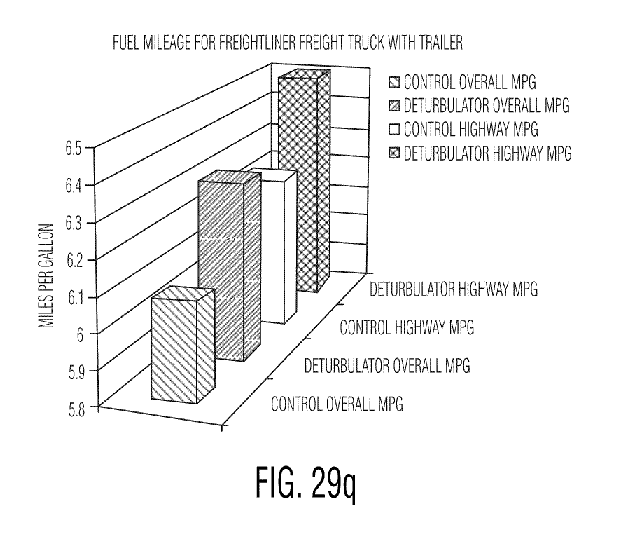

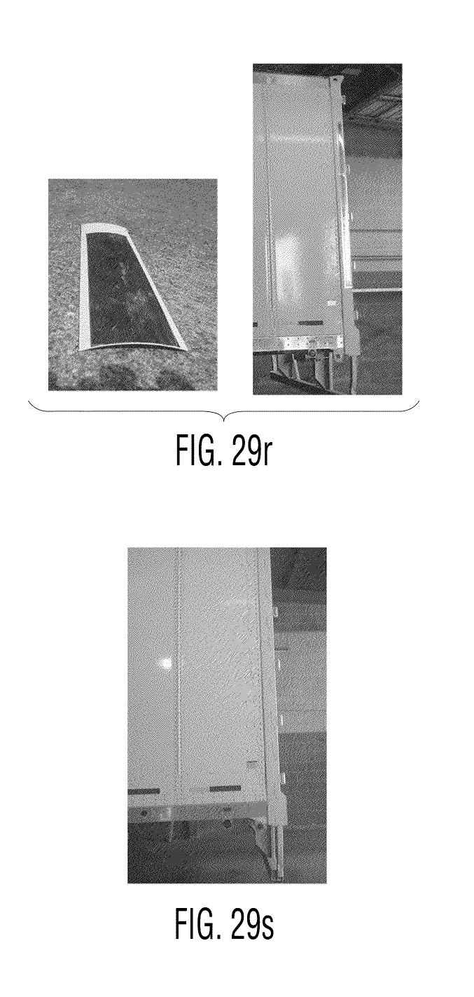

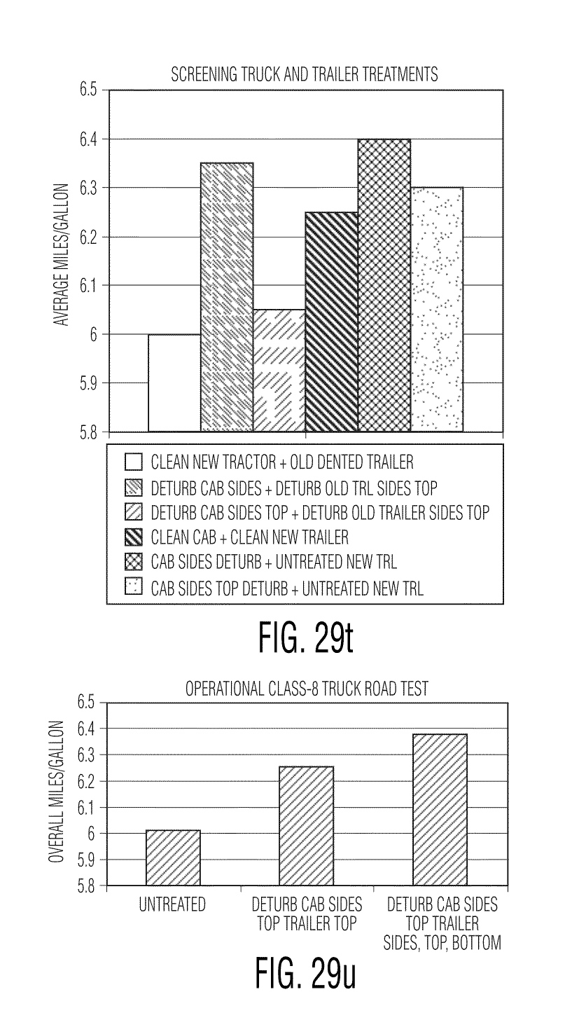

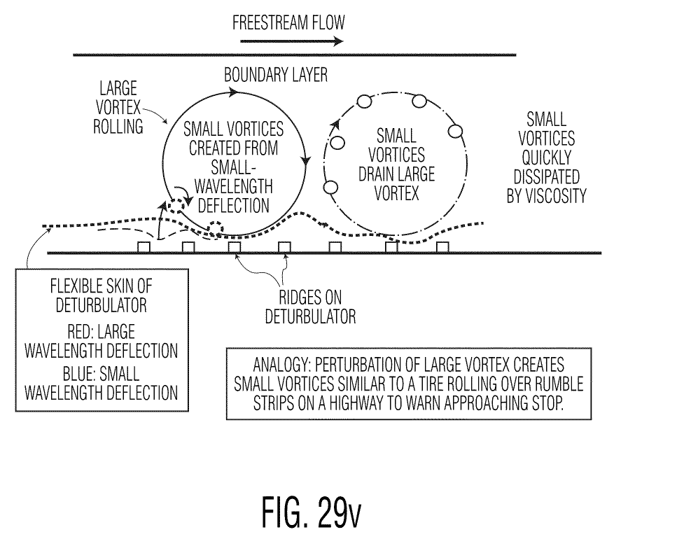

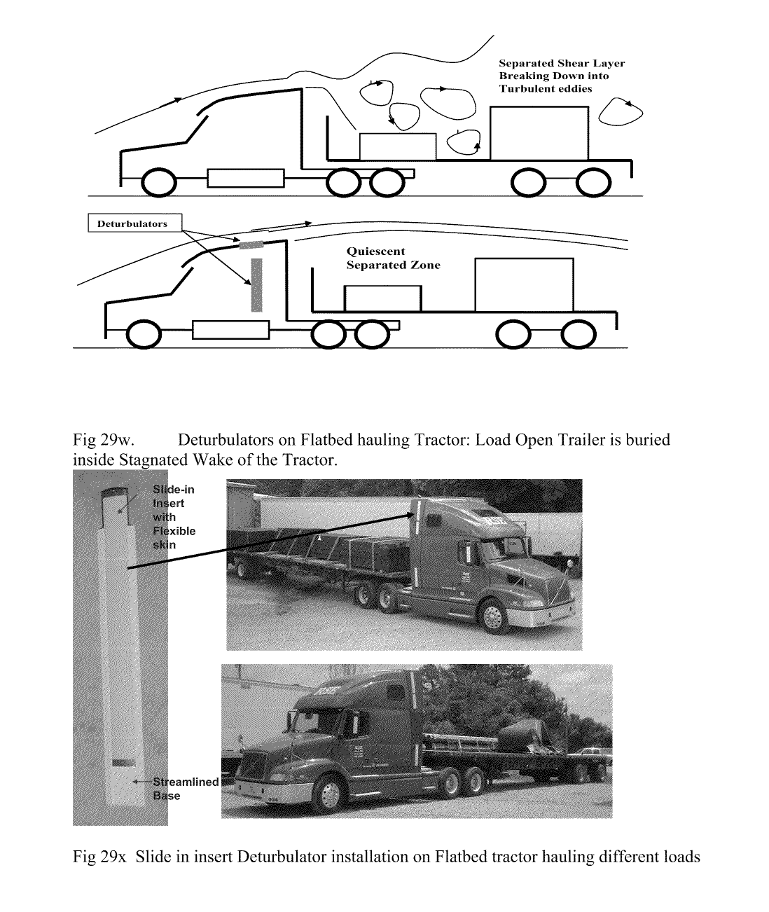

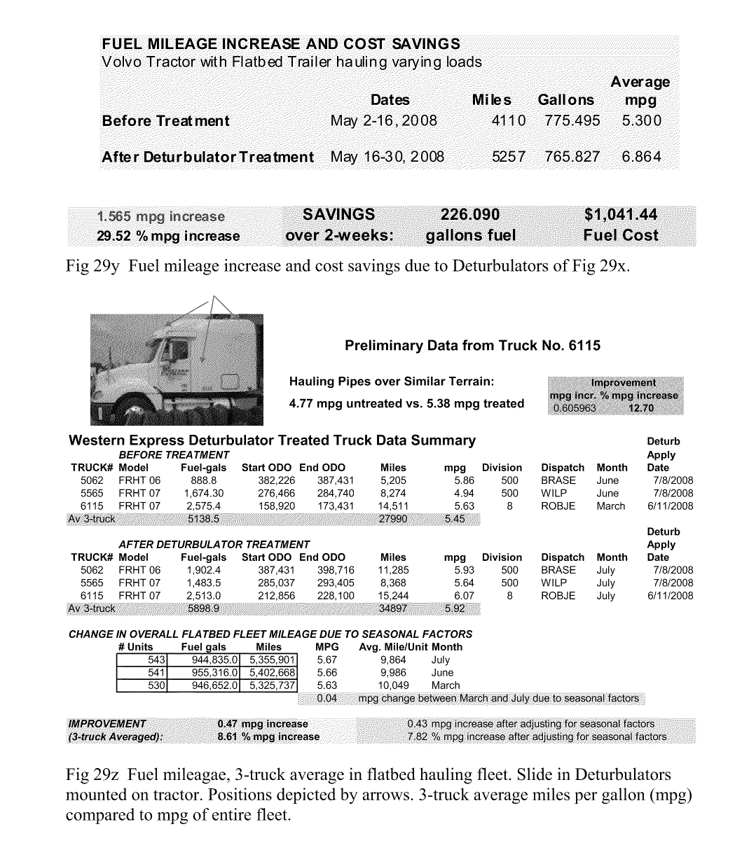

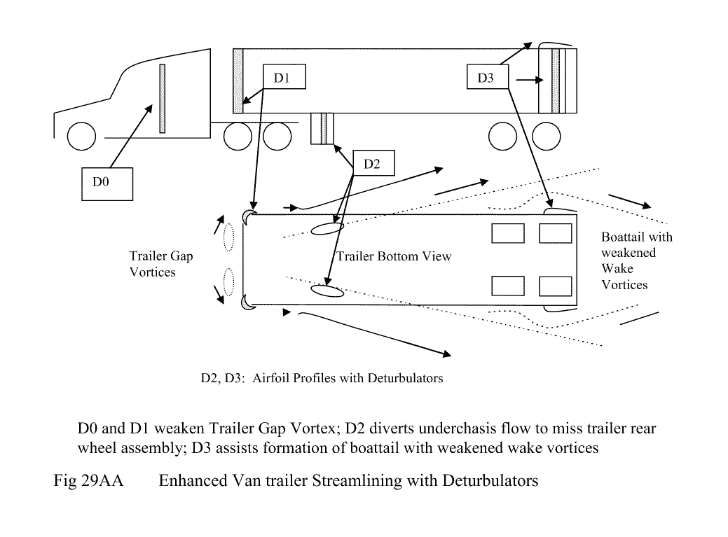

For flows over non-streamlined or bluff bodies, minimizing the extent of separated flow has been the traditional approach. The method disclosed here relies on using deturbulators at selected portions of the surface (FIG. 25) of such objects in order to reduce mixing in the shear layer separating the core of the wake from the freestream flow. In this manner, the deturbulator prevents the development of turbulent eddies in the wake which are a necessary conduit for draining kinetic energy from the main flow. The resulting wake is essentially stagnant and behaves as a solid extension of the bluff body streamlining its aft region. This reduces drag. In this manner deturbulators similar to the FCS in FIG. 1 can also be used to streamline road vehicles (FIG. 25) and other bluff or partially streamlined objects whose functionality precludes the addition of boat tails or other shapes for further streamlining. Enhancing turbulence in the flow over such objects, such as through dimples on golf balls, can reduce drag to a certain extent by reducing the size of the wake but cannot eliminate it altogether. However, converting the wake to a virtual streamlined extension can reduce more drag since the possibility of eliminating all turbulent dissipation exists. FIG. 26 shows a backward facing step behind the windshield and a FCSD just upstream of the rear windshield of a model vehicle in the wind tunnel. FIG. 27 shows the reduction in drag due to the various combinations of step and FCSD at a Re of 0.4-million. FIG. 28a and FIG. 28b shows the same treatment on a 2000 Honda Odyssey EX minivan. Due to larger Re (about 8 million), the front step has been replaced with FCSD on the prototype minivan. FIG. 29a measured improvement in highway gas mileage and FIG. 29b shows an increase in overall mileage resulting from the treatment of FIG. 28a and FIG. 28b.

FIG. 29c shows the hypothesized effect of applying Deturbulator strips to a truck cab, while FIG. 29d shows an actual installation. 2.4-4.3% increase in mpg (miles/gallon) was measured due to applying Deturbulator strips on the sides of the cab only if the severely damaged cab and trailer top Deturbulators are assumed to have no influence on drag). Oil flow tests can be conducted after extending the treatment on the tractor sides to cover more of the vertical face of the cab. The Deturbulator strips modify the separation and reattachment characteristics. For example, treating the sides of the cab as per FIG. 29d reduced the width of the separated zone at the rear end of the trailer as evidenced by oil flow visualization. Also, attempt to treat the bottom of the tractor. A cross member may be attached near the rear of the tractor and mount deturbulator strips over it. The expectation is that it will keep the flow under the tractor and trailer from impacting the tractor differential and trailer undercarriage.

The aforementioned treatment will be initially carried out with existing Deturbulator Strips. They will be repeated after the Deturbulator strips are further optimized.

The Deturbulators used for the tests will have optimized ridge geometry and spacing. Also the Deturbulators need to made as robust as possible. The basis for doing is as follows. The highest frequency in the turbulence fk over the Deturbulator can be scaled by assuming the local rate of dissipation of flow kinetic energy E is entirely due to turbulent skin friction, characterized by the local skin friction coefficient Cf.

ε˜C_{f}·(ρU²/2)·U˜U³ (2)

This yields:

fₖ˜U² (3)

Since fₖ is the highest useful value of f, maximizing the ratio f/fₖ˜(U/s)/U²=1/(U·s) requires minimizing the ridge spacing s for a given freestream velocity U.

The primary forces which determine the flow-membrane interaction efficacy are:

Forcing due to the flow, which scales as v·∂u/∂y| wall where u is the streamwise (x-direction) flow velocity and v is the wall-normal (y-direction) velocity of the flexible wall. The velocity v scales as T·U, where T is the turbulence level.

Inertia force of the membrane for the deflection amplitude δ associated with mode. This scales as:

ρₘₑₘt s δ f² where ρₘₑₘ and t are the mass density and thickness of the membrane.

Flexural restoring force of the membrane for the deflection amplitude δ associated with mode. This force scales as, δ·E·t³/s² where E is the Young's modulus of the membrane.

If the membrane is simply made thicker to be more resistant to tearing, to preserve the same efficacy of Deturbulation the ratio A of flow forcing to membrane inertia needs to remain unchanged. This ratio simplifies to:

The implication of equation (4) is that for a given value of C_{f}, ρₘₑₘ and δ:

A·U·s/t (5)

To hold A constant the spacing s needs to increase with membrane thickness t. Also a thicker membrane will work provided the added flexural rigidity (i.e., increased t3/s2) does not impose restrictions.

The available design space will be mapped using equations (1)-(5) along with dimensions and properties that have worked in Phase-1. Temporary bonding from condensed moisture of the membrane to the tops of ridges deactivates the Deturbulator. Therefore, the ridges will be made narrower with a rounded top. Initial screening will involve using the laser-scored substrates to make Deturbulators which can be mounted on to the cab of the 1/48 scale model tractor for evaluation in the Sinhatech subsonic wind tunnel. The wake of the tractor cab will be scanned with a hot-wire probe to determine profiles of mean and rms-fluctuating components of velocity. The thinnest shear later and smallest velocities in the wake will signify the substrate spacing selected. The thickness of the membrane will doubled from 6-μm to 12-μm and changes in wake velocity profiles noted.

The airspeed in the Sinhatech wind tunnel test section will be maintained at 30-m/s (or 67 mph) which is in the range to the maximum governed highway speeds (65-70 mph) of class-8 truck fleets. The Reynolds number and turbulence level will be lower on the wind tunnel model. However, the interaction frequency f and the highest (Kolmogorov) frequency fk will be close to the prototype values. Treating the top of the cab as opposed to the sides will be done in the wind tunnel.

At present the Deturbulator substrate with the ridges is made by roll-embossing Aluminum foil with pre-applied pressure sensitive acrylic adhesive backing. In the latest design, the aluminum coated Mylar membrane is held along its edges to the rigid vinyl strip with aluminum foil tape. The bonding process for final assembly is currently done by hand. This contributes to high labor costs and defects.

A design a system of rollers which will permit feeding in and laminating continuous rolls of aluminum foil tape pre-coated with acrylic pressure sensitive adhesives and the embossed substrate. The ridged substrate on the strip and bottom side of the pre-cut to width aluminum coated Mylar film membrane will be coated with a sponge roller dipped in hydrophobic silicone wax. The vinyl strip with the coated substrate and Mylar film will then the laminated along with two rolls of aluminum foil tape. The assembled Deturbulator strip (FIG. 29e) will be cut to the proper lengths as it exits the laminating roller.

FIG. 29e also shows a preliminary conceptual sketch of a possible “snap-on” mounting method. The method relies on attaching extruded vinyl supports on to the body of the truck with double sided structural adhesive tape (e.g., VHB® from 3M Corp) used extensively by the automotive industry. The actual Deturbulator strips are also based on custom extrusions (FIG. 29e) which snap on to the support. This will permit easy replacement and ensure repeat sales to the same tractor or trailer. The details of the aforementioned process will be brainstormed and a weighted matrix method will be used to select the final design. This will also involve interactions with plastic extruders and/or a thorough search of existing extrusions or other forms of removable fastening. An additional modification includes forming the ridges directly on to the extrusions or moldings and sliding in this piece as an insert in a molded adhesive backed receptacle (FIG. 29x).

The hydrophobic vents include purchased micro-perforated Teflon inserts attached to a pre-punched adhesive tape. This is currently a manual process. A continuous on-line process will be developed to automate this. Vents will be pre-applied to the Deturbulator strips prior to shipment.

The main advantage of the Deturbulator is that it is currently the only tractor-mounted device which can provide 0.1 to 0.2 mpg enhancement over a base of about 6.0 mpg for class-8 trucks. However, the trailer treatments indicated additional improvements through trailer applications. By applying the Deturbulator on the front vertical corners of the trailer, the drag reduction is less affected by cross winds. Also, application of the Deturbulator on the tractor makes the flow less separated around the rear of the trailer. However, applying a Deturbulator strip on the sides of the trailer door requires compromise between aerodynamics and operational considerations. Even though applying the convex vinyl backed strip around the rear corner can help converge the wake behind the trailer, any part of it extending behind the door frame will be crushed against the loading dock seal. An approach that may work will be to increase the width of the vinyl backing from 2.5-inches (63-mm) to 3-inches (76-mm) or more. This will enable the Deturbulator to extend further away from the wall to higher speed flow, increasing the local skin friction and v·∂u/∂y| wall over the membrane. It will also provide a more convergent Coanda surface (portion of the vinyl extending behind the Deturbulator). Screening tests involving repeated short highway runs will be used to optimize this. Overall mpg gain of more than 10% is the target.

On a flatbed or open trailer, streamlining varying shape and size loads has remained a challenge. By applying Deturbulators on the tractor cab, the stagnated cab wake can extend over the trailer (FIG. 29w). The loads are buried in this still air region, making the truck appear more streamlined as evidenced from the 29.5% improved operational fuel mileage (FIG. 29y) of the treated truck of FIG. 29x. Further evidence on a different model lower height cab tractor shows 12.7% increased fuel economy, while the average of three treated tractors in this fleet of over 500 identical model tractors shoed 7.8% improvement above the untreated fleet (FIG. 29z). This data averages over weather and operational conditions and does not subtract idling fuel usage. Increases in the moving fuel usage, excluding idling, will be higher and are estimated around 10% for the 3-truck average.

FIG. 29aa shows an extended Deturbulator installation on a van-trailer hauling truck. Apart from installations on the cab sides and trailer front corners, Deturbulators on airfoil shaped bases are used to reduce underchasis flow drag and close in the wake behind the trailer with a virtual boat tail. The combination is expected to yield over 10% increase in truck fuel economy.

Flow induced flexural vibration of the outer skin of a surface mounted Deturbulator tape couples with broadband turbulent velocity fluctuations in the airflow, forcing them to a higher flow-skin interaction frequency. The turbulence cannot sustain itself at this frequency and dies out. The large turbulent wake behind a road vehicle is transformed into a stagnant and virtually solid streamlined extension when rapid mixing along the edges of the wake is attenuated with the Deturbulator. The aforementioned method for reducing drag by stagnating the wake is in sharp contrast to the currently accepted practice of reducing the size of the wake by promotion of mixing. Since form-drag or pressure-drag results from irreversible flow losses in the wake, stagnating the wake is the only way these losses can be completely eliminated. Hence it stands to reason that the Deturbulator can lower drag much more than methods which employ vortex generators or other forms of mixing to reduce form drag.

A 1/48 scale model of a Freightliner Columbia tractor with a Van or box trailer was tested in a wind tunnel as shown in FIG. 29f. The model was mounted similar to FIG. 29g, which permits direct measurement of the drag force on a rolling vehicle. Oil flow visualization was then used on the model to identify separated areas and attached regions. Based on previous research on the Deturbulator (Sinha and Ravande 2006a,b) the most effective place to locate in on a varying pressure gradient boundary layer flow (e.g., an airfoil) is where the streamwise pressure gradient ∂p/∂x=0. This condition maximizes the influence of the Deturbulator “control term” v∂u/∂y| wall on the streamwise (x-direction) momentum equation (y-normal to wall). For a partially streamlined body, the point of reattachment of a separated flow, if it exists, occurs where ∂u/∂y| wall is maximized. Even though ∂p/∂x may not be zero at this point, this point was selected applying the Deturbulator. Several such locations can be found on a complex shape like a tractor-semi-trailer truck. FIG. 29h shows the final Deturbulator treated truck. FIG. 29i shows reductions in measured drag for various treatments. The best reduction in drag was 25% for the treatment shown in FIG. 29h.

The wake of the tractor trailer truck was scanned with a single element hot-wire probe. The probe was calibrated in the same wind tunnel prior to use. The probe outputs were measured with a true-rms multimeter to obtain the mean and rms voltages. The outputs from the 3^{rd} order calibration equation yielded the mean velocity in the vertical plane (U²+V²)^{1/2} as well as the rms fluctuating velocity <u′²+v′²>^{1/2} as plotted in FIGS. 29j and 29k. The structure of the wake includes signatures of multiple shear layers for this composite body. The mean velocity shows a clear reduction with Deturbulator treatment. The rms velocity fluctuations also show reduction in the vicinity of the shear layers. Measurement of mean velocities above the trailer at ½ the length of the trailer from the rear shows increase in mean velocities due to Deturbulator application while making the shear layer characterized by high rms-velocity fluctuations thinner (FIG. 29l). Hence the reason for the drag reduction of FIG. 29h is clearly due to (i) making the wake more stagnant as per the project hypothesis and (ii) reducing resistance in flow above the vehicle.

Since the wake of the composite tractor-trailer assembly involved multiple shear layers, the development of the shear layers needed to be examined. The first major flow separation occurs behind the tractor cab. The separated shear layers from the cab top and sides drive the recirculating flow in the gap between the cab and trailer. If part of the flow off the cab directly impacts the front of the trailer, the recirculation is further invigorated. Due to the small dimensions of the model it was difficult to examine the details of the flow in the gap. Therefore, the tractor was unhitched from the trailer and the wake behind the tractor cab was examined with the hot-wire probe.

FIGS. 29m and 29n show means and fluctuating components of velocity for the untreated truck and with two different substrate geometries of the Deturbulator. As before, Deturbulator treatment showed reductions in both mean and fluctuation velocities in the wake. This confirmed the theory that the wake was being made more stagnant. The smaller 0.5-mm ridge spacing on the substrate showed a narrower shear layer. Also, the shear layer is centered slightly higher (FIGS. 29m and 29n), showing higher pressure in the wake compared to the 2-mm spaced ridged substrate Deturbulator.

We were however able to obtain access to class-8 trucks for running road tests. We proceeded to verify (after notifying NSF) if the Deturbulator could improve fuel mileage by reducing aerodynamic drag. The tests included oil flow visualizations by dabbing spots of used 5W-30 engine oil on the Freightliner Columbia tractor body, running the vehicle at 65 mph over about two miles, stopping it and photographing the oil streaks. FIG. 290 shows the flow transitioning from complete separation (vertical streaks) to full re-attachment or maximum ∂u/∂y|_{wall} (horizontal streaks). As per the theory discussed, the best place to locate the Deturbulator is to center the tape on the maximum reattachment. At the same time, the leading edge of the tape needs to kept within the separated zone. This is to avoid the forward facing step created by the leading edge of a 100-μm thick tape from blocking the attached boundary layer flow.

Initial Deturbulator installation on the sides of the tractor left the miles per gallon downloaded from the tractor-CPU unchanged. The oil flow tests were done on the tractor after unhitching it from the trailer. This resulted in a 2-inch (50-mm) error in determining the optimum location of the Deturbulator since it was discovered in a subsequent test that the presence of the trailer changes this location. The fact that trailers are slightly wider than the tractor cabs (even with the extended fairings) exacerbates this error. Also the optimum locations on the wind tunnel model did not coincide with the full-scale truck. FIG. 29p shows the first successful installation on a tractor trailer truck. 4% increase in overall mpg with 97% significance in t-tests was obtained with Deturbulators on the sides of the cab, top of the cab and top rear of the trailer (FIG. 29q).

In many trucking operations the same tractor is used to haul different trailers to eliminate tractor idle time during loading and unloading a trailer. This increases the number of parameters to be controlled in order to accurately determine fuel efficiency change. In Phase-1 trucks were provided by two companies: (1) Western Express, Nashville, Tenn. (operates about 1600 tractors and seldom keeps tractors and trailer together) and (2) Empire Express, Memphis, Tenn. (operates about 75 tractors and keeps tractors and trailers together on a few select routes). The Empire Express truck selected (FIG. 29p) remained hitched and delivered main overnight between Baton Rouge, La. and Pensacola, Fla. traveling on fairly flat stretches of Interstate along the Gulf of Mexico. Fuel fill up data was maintained by the driver from January-March 2007 prior to Deturbulator treatment. Historical average annual mpg data downloaded from the truck's CPU was also maintained by Empire Express. In FIG. 29q, the highway mileage was estimated by subtracting fuel consumed during idling. Idling time was recorded by the truck driver and verified against data downloaded from the truck CPU.

Reconfiguring the Deturbulator for Trucks: Surfaces of trucks are not smooth compared to aircraft wings or automobiles. The Deturbulator tape was therefore pre-mounted on smooth vinyl strips. The semi-rigid strips were taped on to the sides of the tractor and trailer, with the edges of the 1-mm thick vinyl tape located in separated flow regions. The vinyl strips also had a slight convex curvature (FIG. 29r). The Deturbulator tape was mounted after flattening the vinyl strip, such that elastic recovery of the vinyl helped maintain a level of pre-tension on the Deturbulator membrane after installation. The “Deturbulator Strips” thus configured were also easier to mount on a truck. A 6-ft (2-m) long Deturbulator strip (FIG. 29r-right) can be installed in 15 minutes compared to 1-hour for the tape. Also, considerably less skill is needed. However, the installation time for a 6-ft (2-m) strip needs to be reduced to a minute or less to be acceptable to truck operators. This is particularly important if strips need to be replaced regularly to maintain performance levels. We have determined that by customizing the cross section of the vinyl strips it is possible to snap or slide in a Deturbulator strip at a given location within 15-20 seconds. A matching system of supports needs to be applied to the vehicle as part of the initial treatment.

Optimizing Deturbulator Locations: Treating one section, such as the cab sides with the Deturbulator modifies flow separation at other locations like the rear side of the trailer. Oil flow tests on three untreated trailers indicated completely separated flow along the entire side of the trailer even with moderate cross winds. However, treating the sides of the tractor cab reduces the separation such that the flow is marginally re-attaching near the rear end (FIG. 29s). Additionally, the slightly concave strip (FIG. 29r) further extends the Deturbulator into the outer flow, increasing the effective ∂u/∂y|_{wall}. Also, Coanda effect on the curved vinyl strip deflects the flow towards the center of the trailer, reducing the size of the wake.

The existing OEM wind deflector integrated with the tractor cab (FIG. 29p) encourages the flow to separate such that it misses the top front corner of the trailer. The top of the tractor cab was found to be a desirable place for locating the Deturbulator in order to minimize energy dissipation in the aforementioned separated flow. This was also reinforced in the wind tunnel tests (FIGS. 29h and 29i). However tests aimed at screening various Deturbulator treatment combinations clearly show increase in drag for a cab top Deturbulator strip (FIG. 29t). The reason for this is a slight downward deflection of the separated shear layer which results in the high speed flow no longer missing the corner of the trailer. Furthermore, the height of the trailer above the mounting plate (or “fifth wheel”) can easily vary by as much as 1-inch (25-mm). A Deturbulator strip on the cab roof needs to be optimized for each trailer. This is clearly impractical. Also, trucks often brush against low handing tree branches especially when passing through small towns. For example, the cab-top Deturbulator and the trailer rear top Deturbulator were found to be damaged in the operational Empire Express truck. We have therefore concluded that Deturbulator strips should not be mounted on the top of the cab. It may be mounted on the top rear of a trailer provided the truck avoids routes with low hanging branches. A stronger reattachment exists on the top rear corner of the trailer.

FIG. 29t reflects the average of truck CPU measured trip mpg with zero indicated idling time over 8 to 8.2 mile segments on Briley Parkway, Nashville Tenn. at 65 mph. A brand new Freightliner Columbia tractor, a slightly dented Great Dane trailer (FIG. 29o-right) and a new undamaged trailer, all supplied by Western Express, were used. The data has not been corrected for accelerating, braking, road slope and wind conditions. It however clearly shows a comparison between treatments and also shows that cab-top treatment is undesirable. Similar treatments (e.g., 5.21% cab sides and trailer top, vs 5.83% cab sides trailer corners and trailer top) produced similar percentage improvements in mpg. Deturbulator treatment over dented corners of the Western Express provided old Great Dane trailer appears to bring it closer to a new un-dented trailer.

FIG. 29u shows long term (1.5 to 3 months average) data downloaded from the CPU of the older operational Freightliner Columbia tractor with a good condition Wabash 53-ft trailer supplied by Empire Express. It should however be emphasized that the Deturbulator on top of the cab was completely destroyed when the truck was examined. The Deturbulator on the top rear of the trailer was also significantly damaged. A comparison between comparable data and treatments in FIGS. 29t and 29u show that by installing Deturbulators on the sides of the cab and trailer and on top (rear) of the trailer the fuel mileage can be increased from 6.0 to about 6.35 or 5.8%. The last treatment in FIG. 18 also included a Deturbulator on the bottom rear of the trailer (below the safety bar) that was found undamaged.

### Major Findings

A 2-6% improvement in fuel economy of operational class-8 tractor trailer trucks has been demonstrated. This level of improvement is significant to be of interest from truck fleet operators even though it is lower than improvements obtained on more streamlined light vehicles. The best competing device (trailer skirts) provide 4% improvement in fuel economy and is difficult to replace if damaged. This, coupled with the fact that Deturbulator strips on the sides of the cab and trailer have survived for four months on an operational truck justifies proceeding to Phase-II. The fuel economy can be increased to 10% by reducing Deturbulator ridge spacing, eliminating damaged Deturbulators and adding more Deturbulators to the bottom of the trailer

The hypothesis that Deturbulation reduces flow and turbulence levels in the wake of a bluff body has been unequivocally demonstrated in wind-tunnel experiments. Turbulent fluctuations could be captured within a narrower mixing layer by reducing the spacing between ridges on the Deturbulator substrate. This fact has let us re-examine the physics of flow-membrane interaction and reformulate a new simplified model as depicted in FIG. 29v. The ridges on the substrate break up long traveling waves which are the footprint of large-scale turbulence producing eddies. The spacing of the substrate determines the size of the smaller eddies that emerge. This bypasses a large section of the turbulent eddy breakdown cascade which helps minimize the effective eddy viscosity. A smaller eddy bypasses more of the turbulent cascade and accounts for the narrower shear layers.

The problem of Deturbulator deactivation due to moisture condensation has been solved for ground vehicles by a combination of hydrophobic coating and micro-porous vent insets. The successful tests by the operational Empire Express truck on the very humid Gulf of Mexico coast further reinforce this. Also most of the data in FIG. 29t was obtained during rain.

According to the system and method disclosed herein, the present invention provides numerous benefits. For example, it can enhance heat transfer in a variety of applications while minimizing or lowering the drop in flow pressure, or reduce aircraft wing drag or make fans more efficient and quiet.

Additional use of the Deturbulator is claimed for improving efficiency, increasing stall-free operating range of wind speeds and wind direction and reducing noise of wind turbine blades.

The installations of the Deturbulator are claimed in two sailplanes: (1) the Sparrowhawk (same wing as the OWL UAV); followed by (2) The installation on the standard cirrus sailplane and its flight test results independently confirmed. These designs also indicate the general layout for other wings and airfoils, including wind turbine and propeller and lift producing rotor blades.

Use of Deturbulator in a liquid environment. Replace air gap with liquid gaps (e.g., water in the space between the membrane and substrate).

Use of Deturbulator in electrically charged fluids and plasmas. A passive electrical mode is to be used comprising imbedded interconnected electrodes.

Integrate the Deturbulator with automatic or manually deployable flaps for preventing the upstream spreading of trailing-edge separation, in order to extend operation to higher Reynolds numbers (larger speeds and sizes).

Include the Deturbulator along with a tape flow pre-conditioner to reduce drag by limiting the extent of high static pressures on the leading edge of a blunt object (e.g., automobile mirrors).

Additional Features relating to Issued U.S. Pat. No. 5,961,080, Oct. 5, 1999

Using the active flexible wall (Patent by Sinha 5,961,080, Oct. 5, 1999) to detect separation location, estimate free stream velocity and wall shear stress.

Following is an example implementation:

### A Flight Test Evaluation of the Wing Performance Enhancing Deturbulators

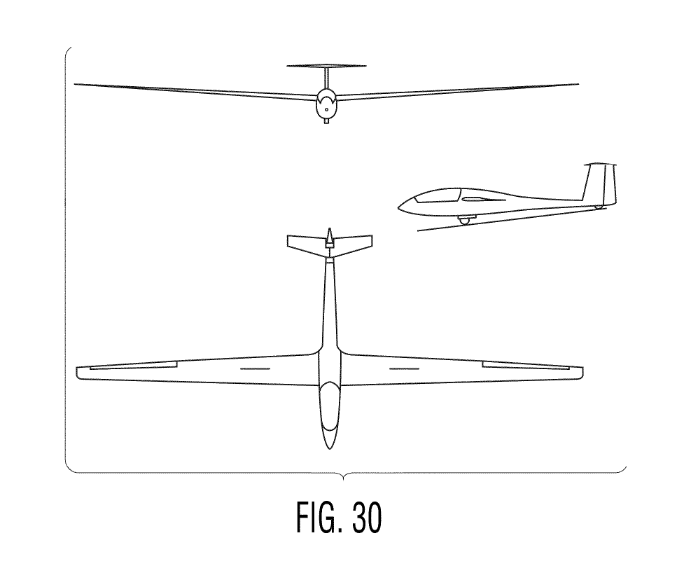

FIG. 30 presents a 3-view of Std. Cirrus, a 15 meter test bed sail plane. The wing surface distribution is a full length, spanwise mounted, strip of very thin and flat, silvered Mylar hollow tubing that is about 50 mm (1.98 inches) wide. Mounted on the wing top surfaces at about 0.65 chord distance from the wing leading edge, it is designed to filter out small turbulence waves in the wing's boundary layer by a process called dynamic flow control. In addition to the 50 mm wide silvered deturbulator strips, the wing forward leading edges were treated with a proprietary coating, designed to improve the wing airflow boundary layer characteristics. Somehow that, in addition to the well aft mounted deturbulator strip, aided the wing chordwise airflow in creating less skin friction drag; thus significantly improving glide performance.

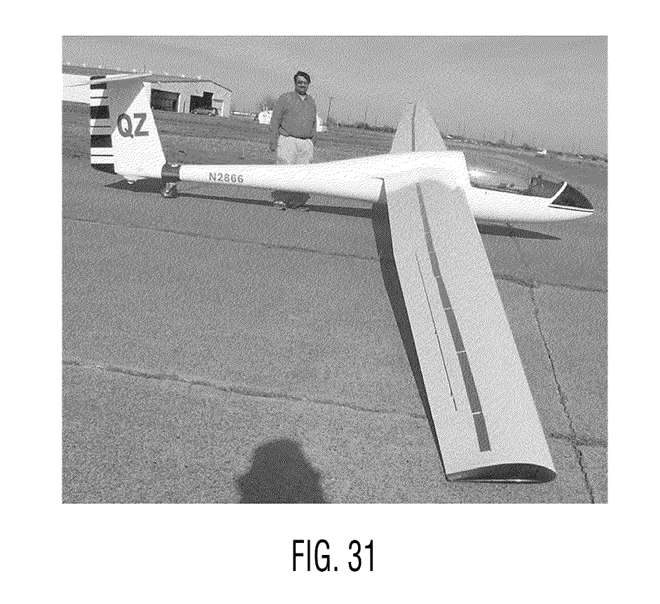

A man with the Deturbulator strips mounted on the test Std. Cirrus is shown in FIG. 31.

### Airspeed Calibration

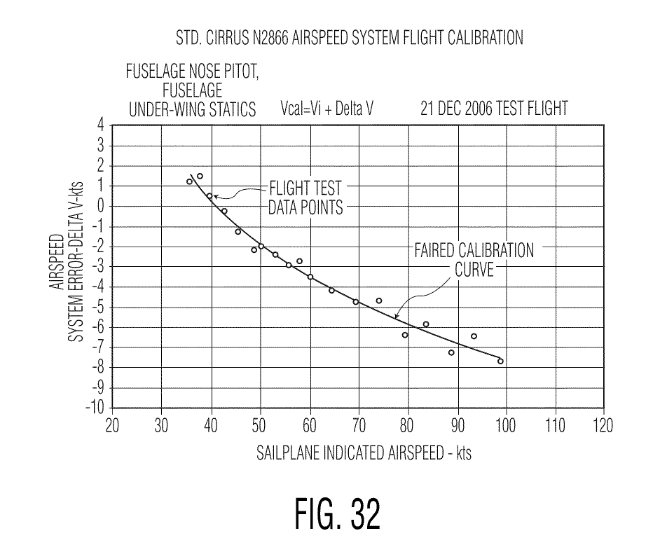

The Std. Cirrus airspeed system uses a fuselage nose pitot tube that is located in the cockpit ventilation air inlet. Small vent holes on the fuselage sides below the wing serve as its static sources. First we checked the pilot and static system lines for leaks, and repaired a small one. Then, while inside the hangar and out of the wind, the sailplane's Winter airspeed indicator was calibrated by carefully comparing its readings to our calibrated reference ASI meter. The errors that were measured for the sailplane's Winter ASI were relatively low, less than about 2 knots over our entire planned flight test range. Those measured airspeed indicator instrument error data are shown in FIG. 32.

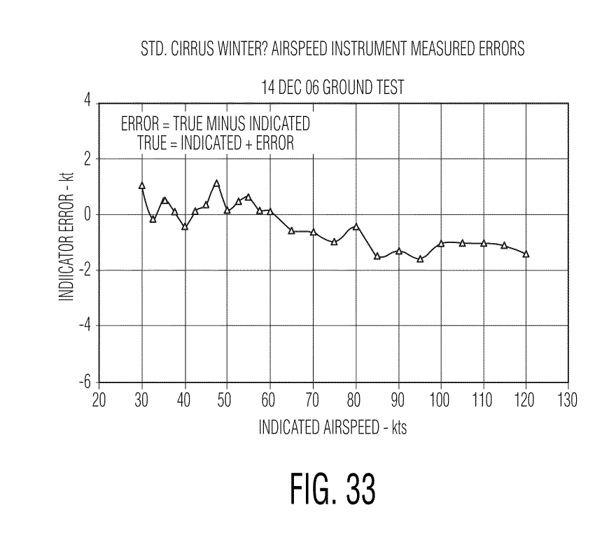

An airspeed system flight calibration is performed while descending from an 11,000-foot high tow. For that the sailplane was equipped with a Kiel tube reference pitot temporarily taped to one side of the canopy, and a trailing bomb static reference, deployed in flight after tow release. The flight test calibration was then steadily flown at indicated airspeeds between 35 and 100 kts, comparing our master reference indicated airspeeds to those of the sailplane's. Those test data were then used to compute the Std. Cirrus's airspeed system errors versus indicated airspeed. The FIG. 33 chart presents the flight measured Airspeed System errors. In that figure it is assumed that the airspeed indicator has no errors, and that the errors shown would be those using a perfect ASI. The Std. Cirrus's airspeed system measured errors were small at relatively low airspeeds, but increased almost linearly to about 7 kts at 100 kts indicated airspeed. In general, the test data measurements show that the Std. Cirrus is actually flying considerably slower than the indicated airspeed, but only when flying at airspeeds above 50 kts.

While the under-wing fuselage side static pressure orifices provide a highly biased static pressure source, it is reliable and almost impossible to clog when flying in rain. That is a good point and it adds to flight safety. In the past, a number of sailplanes have had crashes when trying to land in rain with an inoperative airspeed indicator.

### Sink Rate Test Flights

The first 6 flight sink rate measurement tests were made with the full-span Sinha deturbulator tapes carefully mounted on Std. Cirrus's wing top surfaces. The atmosphere was relatively calm that day with little vertical air motion or horizontal wind shear at the flight test altitudes during the tow to 12,000 ft. On the way down the Std. Cirrus sink rates were measured at various airspeeds between 35 and 100 kts indicated airspeed. Alternately three more sink rate test flights were flown to take measurement.

To determine how much benefit the deturbulators provided, it was necessary to re-test our Std. Cirrus test-bed sailplane with the deturbulators removed. Therefore, three more high-tow sink rate test flights were made, with the deturbulators removed. The weather appeared to be relatively calm that day.

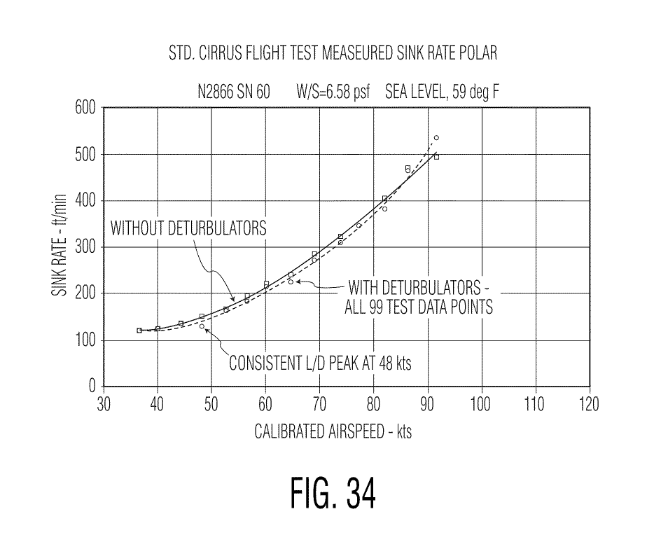

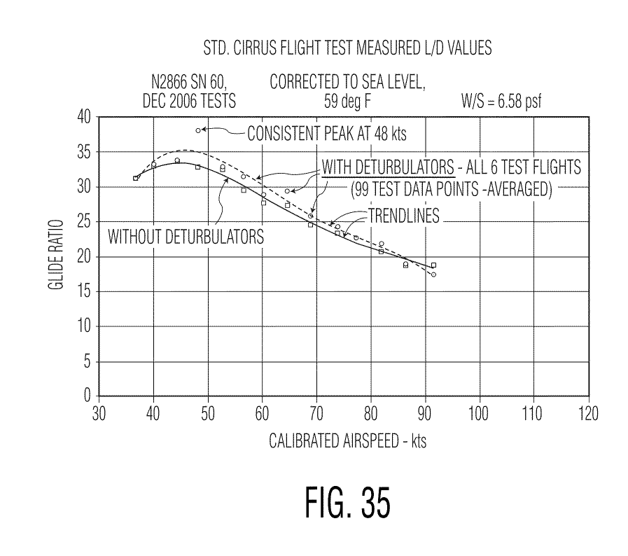

With a total of 9-sink rate and 1 airspeed calibration test flights in-hand, it was possible to correct the sink-rate data to standard 59 deg F. sea level conditions, as is customary. FIG. 34 shows the averaged sink-rates measured during the 6 deturbulated-wing test flights, and FIG. 35 shows their corresponding L/D ratios. Also shown are the similar test data for the 3 deturbulator-removed test flights.

Those test data indicate that the deturbulators improved the Std. Cirrus best glide performance from about 33.5:1 at 44 kts, to about 35.2:1 at 46 kts, an improvement of about 5 or 6%. These numbers are derived from a 4th order trend-line drawn through the test data points. For some reason, the many-point averaged deturbulated wing test data at 48 kts shows a well-above trend-line L/D point of almost 38:1, an improvement of about 13%. Above 90 kts the deturbulators showed a slightly higher drag than with the clean wings.

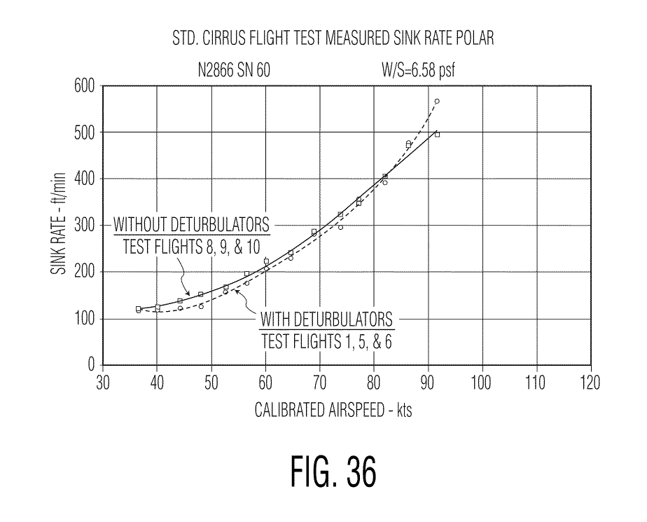

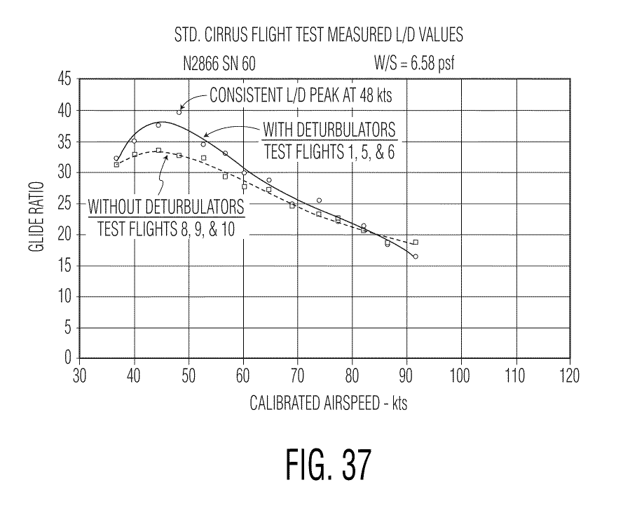

As stated earlier, the atmosphere appeared less calm during the afternoon when the deturbulated test Flights 2, 3, & 4 were flown. Therefore, the test data was reanalyzed after eliminating those three flights, using only the test data from Flights 1, 5, & 6. The deturbulated wing test data from those three test flights show considerably less data scatter than did Flights 2, 3, & 4. FIG. 36 shows the averaged sink-rates measured during the selected 3 deturbulated-wing test flights. FIG. 37 shows their corresponding L/D ratios. Also shown in both figures, for comparison, are the test data for the deturbulator-removed test flight data.

Those test data indicate that the deturbulators improved the Std. Cirrus best glide performance from about 33.5:1 at 44 kts, to about 38:1 at 46 kts; an improvement of about 13% in L/Dmax. These numbers are again derived from a 4th order trend-line drawn through the less-scattered test data points. The many-point averaged deturbulated wing test data at 48 kts still shows a well-above trend-line L/D point of almost 40:1, an improvement of about 18% over that of the clean-wing data. The above-90 kt data with the deturbulators still showed a slightly higher drag than with the clean wings.

### Wing Surface Waviness Measurements

Using our standard 2-inch long wave gage, chordwise waviness measurements were performed of our test Std. Cirrus's wing top and bottom surfaces at 14 spanwise stations along each wing panel. The magnitudes of wing's surface waves were quite nominal, averaging only about 0.0044 inches peak-to-peak. That is relatively good, especially considering the sailplane's age. Only on the outer wing panel did our measurements much exceed that value. Those waviness measurements are for peak-to-peak magnitudes—from valleys to peaks.

### DISCUSSION

The higher deturbulated wing drag at the highest airspeeds is explained by the following. At high descent rates the stretched Mylar cover film suffers from inadequate outside venting of the hollow cavity below the silvered Mylar film. Therefore, the rapidly increasing ambient air pressure forces the Mylar film down hard enough to prevent it from flexing and functioning properly at high sailplane sink rates. If that is the case, it should not be difficult to increase the deturbulator venting somewhat, and allow it to continue its good work at higher speeds.

The thickness of the basic hollow uninflated deturbulator strip is only about 0.3 mm (0.012 inches) plus about 0.1 mm (0.004 inches) for the thin layer of adhesive that attaches it to the wing surface. That total thickness of 0.4 mm (0.0158 inches) is surprisingly thin, and that equals the thickness of about 4 sheets of computer printing paper. The strip can be, for example, a thin nano fiber strip. Accordingly a thin strip can produce significant improvements to a sailplane's performance.

### SUMMARY

The new Deturbulator could be is a really significant drag-reducing aerodynamic invention since the development of the now-common laminar-flow airfoils that were developed some 65 years ago. Its small size and lightweight make it easy to apply on a sailplane wing. Its location on a sailplane wing may be critical, and if similar performance improvements can be achieved with the many types of high performance sailplanes.

Although the present invention has been described in accordance with the embodiments shown, one of ordinary skill in the art will readily recognize that there could be variations to the embodiments and those variations would be within the spirit and scope of the present invention. For example, any of the embodiments shown could be used in a variety of applications and its use would be within the spirit and scope of the present invention. Accordingly, many modifications may be made by one of ordinary skill in the art without departing from the spirit and scope of the appended claims.

What is claimed is:

1. A method for reducing drag for a streamlined body comprising:
providing a small viscous sublayer scale backward and/or forward facing steps on the surface of the body, where the backward facing step is in a favorable pressure gradient and forward facing step is in an adverse pressure gradient, so as to speed up the freestream flow over the front portion of the airfoil or body and reduce skin friction drag by creating a marginally separated thin slip layer next to the wall behind the backward facing step and extending a significant distance behind said step.

2. The method of claim 1 which includes:
providing a deturbulator, such that the boundary layer is attached on the surface of the deturbulator to enable speeding up the freestream flow through the slip layer at higher Reynolds numbers and for a range of angle of attacks of the airfoil or orientation of the streamlined body with respect to the oncoming flow.

3. A method for reducing drag for a streamlined body comprising:
utilizing a row of equispaced viscous sublayer scale protrusions upstream; and
utilizing a deturbulator so as to synergistically enhance the action of the deturbulator and prevent breakaway separation through the promotion of streamwise vortices in the boundary layer flow.

4. The method of claim 3 wherein the protrusions and the deturbulator are utilized on the upper surface of a wing or lifting body to enhance lift.

5. The method of claim 3 wherein the deturbulator is utilized on the upper surface of the wing or lifting body is changed to enhance lift.

6. The method of claim 4 and 5 skin friction drag and form drag are reduced simultaneously.

7. The method of claim 6 wherein the spanwise lift distribution is changed on a wing to reduce the severity of wing-tip stall, reduce wing bending loads or increase the span efficiency by applying method selectively over portions of the wing span.

8. A method of reducing form drag of non-streamlined bluff bodies comprising:
affixing a deturbulator to selected regions of the surface of the said body where skin friction maximizes so as to make the wake less turbulent and behave as a virtual solid boat tail extension of the body to streamline the flow.

9. The method of claim 8 wherein the bluff body is a land vehicle such as a car, van, truck or trailer, whereby the fuel efficiency of the vehicle is enhanced without changing its shape or functionality attributable to the shape.

10. The method of claim 8 where the vehicle is a tractor hauling varying shape and size loads on an open trailer such that the trailer and load stay submerged within the solid boat tail extension.

11. The method of claim 8 wherein the bluff body is a wind deflector mounted on or under a car, van, truck or trailer.

12. The method of claim 2 wherein the deturbulator is mounted on a slightly convex substrate to enhance action across a range of angles of attack.

13. The method of claim 8 wherein the deturbulator is mounted on a slightly convex substrate to enhance action and reduce the length of the boat tail.

14. The method of claim 9 where the deturbulator is removeable from its base for periodic replacement.

15. The method of claim 14 where the deturbulator is in the form of a strip which can slide into a shaped adhesive backed receptacle.

16. The method of claim 14 where the flexible membrane of the deturbulator is fiber reinforced flexible composite with the fibers on the neutral axis and films on the outside.

17. The method of claim 14 where the flexible membrane of the deturbulator is a thin nano fiber reinforced composite.
